(19) United States
(12) Patent Application Publication
(10) Pub. No.: US 2026/0358929 A1
(43) Pub. Date: Nov. 12, 2026

(54) ADAPTIVE AI AGENT WITH PERSISTENT USER INTERFACE GENERATION AND MULTI-USER INPUT PROCESSING

(71) Applicant: monday.com Ltd., Tel Aviv (IL)

(72) Inventors: Roni AKSELROD, Ramat Gan (IL); Matan LACHMISH, Netanya (IL); Shai MISHALI, Shoham (IL); Elad DOUENIAS, Tel Aviv (IL)

(73) Assignee: monday.com Ltd., Tel Aviv (IL)

(21) Appl. No.: 19/450,863

(22) Filed: Jan. 16, 2026

Related U.S. Application Data
(60) Provisional application No. 63/802,765, filed on May 9, 2025.

(51) Int. Cl. G06F 3/0481; G06F 40/205; H04L 51/04

(52) U.S. Cl. CPC G06F 3/0481; G06F 40/205; H04L 51/04

(57) ABSTRACT

A system for generating adaptive user interfaces through AI agents comprises a messaging GUI enabling message exchange between users and AI agent instances. The system parses natural language inputs from user messages and maintains conversational context based on analysis of the parsed inputs. Based on conversational context, the system creates persistent UI widgets rendered as part of the messaging GUI and updates these widgets as users continue interactions with the AI agent. The system enables hybrid interaction between conversational and structured interface modes while supporting multi-user input processing. The system receives concurrent inputs from multiple users, executes decision phases to identify aligned and conflicting instruction sets, and generates unified outputs through computational fusion of user directives, enabling AI agents to function as collaborative team participants.

### RELATED APPLICATION/S

This application claims the benefit of priority of U.S. Provisional Patent Application No. 63/802,765 filed on May 9, 2025, the contents of which are incorporated herein by reference in their entirety.

### FIELD AND BACKGROUND OF THE INVENTION

The present invention relates to artificial intelligence systems and user interfaces, and more particularly to systems and methods for generating adaptive user interfaces through AI agents that can process conversational inputs and create persistent visual components, as well as handle concurrent multi-user inputs in collaborative environments.

Conversational AI agents have become increasingly prevalent in modern computing environments, particularly in collaborative work systems and Software-as-a-Service (SaaS) platforms. Traditional AI agents typically operate through chat-based interfaces that excel at flexible, moment-to-moment interactions but suffer from significant limitations when users require management of complex data or maintenance of stable visual overviews. Users cannot easily visualize data trends, track historical progress, or access persistent control panels, forcing them to rely on transient chat messages and memory retention. This creates a substantial usability gap between the fluidity of conversational interfaces and the structured control mechanisms provided by traditional applications.

Existing AI agents are primarily designed for one-on-one interactions and lack frameworks for handling input from multiple users simultaneously. In team environments, conventional AI agents cannot function as true collaborative partners because they lack consistent mechanisms through which multiple users can meaningfully interact with the same AI agent in a shared space. This prevents AI agents from acting as collective resources for teams and limits their utility in collaborative workflows.

Current approaches to user interface generation are typically static and require manual configuration. Users must explicitly create and maintain interface components, which creates friction in workflows where interface needs evolve dynamically based on user interactions and changing requirements. The lack of persistent, adaptive interfaces that can evolve based on conversational context represents a significant limitation in current AI agent implementations.

Furthermore, existing systems fail to provide mechanisms for multiple AI agents to interact with and adapt the same interface components, limiting the collaborative potential between different AI agents within the same system. There exists a need for AI agents that can bridge the gap between conversational flexibility and structured application interfaces while simultaneously supporting multi-user collaborative interactions.

### SUMMARY OF THE INVENTION

The present invention provides systems and methods for AI agents with adaptive, persistent user interface generation and multi-user input processing capabilities. The disclosed embodiments address the limitations of conventional AI agents by providing dynamic interface generation based on conversational context and sophisticated multi-user input fusion mechanisms.

The disclosed systems and methods are particularly applicable to Software-as-a-Service (SaaS) platforms that provide collaborative work management capabilities. Such SaaS platforms typically employ a distributed architecture comprising centralized server infrastructure that hosts application logic, data storage, and AI processing capabilities, along with remote client devices that access the platform through web browsers, mobile applications, or dedicated desktop clients. The server infrastructure may include load-balanced application servers, database clusters, message queuing systems, and dedicated AI inference engines. Remote clients receive rendered graphical user interface components from the server and transmit user inputs back to the server for processing.

In conventional SaaS collaborative platforms such as project management systems, customer relationship management systems, and team communication platforms, users interact with structured data through table-based interfaces, Kanban boards, dashboards, and document editors. While these platforms excel at structured data management, they typically maintain a separation between conversational interfaces (such as chat threads and comment streams) and structured data visualization components. This architectural separation requires users to manually navigate between conversational contexts and data visualization tools, creating cognitive overhead and workflow interruption.

Furthermore, existing SaaS platforms that incorporate AI-powered features typically implement AI assistance as isolated functions—such as text generation, auto-completion, or simple question-answering—rather than as integrated agents capable of dynamically modifying the user interface based on conversational context. The AI components in conventional systems lack persistent awareness of user interaction patterns and cannot autonomously generate or modify interface components in response to detected user needs.

According to certain embodiments, a first aspect of the invention relates to an AI agent system that generates adaptive user interfaces. The system presents a messaging graphical user interface (GUI) enabling message exchange between users and AI agent instances. The system parses natural language inputs from user messages and maintains conversational context based on analysis of the parsed inputs. Based on this conversational context, the system creates persistent UI widgets that are rendered as part of the messaging GUI. The system continuously updates these persistent UI widgets as users continue interactions with the AI agent, including adding, removing, or modifying widgets responsive to changes in conversational context.

The system enables hybrid interaction modes where users can seamlessly alternate between issuing natural language commands through the chat interface and performing structured operations through persistent UI widgets, with state synchronization maintained between both interaction modalities. The persistent UI widgets may remain visually fixed within the messaging GUI independent of scrolling message streams and may persist across multiple user sessions and/or client devices by storing widget state in durable storage and restoring the widget upon session resumption.

Technical benefits of this approach include improved user workflow efficiency by eliminating the need to recreate interface components repeatedly, enhanced data visualization capabilities that emerge naturally from conversational patterns, reduced cognitive load by providing persistent visual references for complex data, and seamless integration between conversational and structured interaction modes.

According to certain embodiments, a second aspect of the invention relates to multi-user input processing systems. The system receives input messages from multiple distinct users within defined time windows that establish context windows. The system executes decision phases that identify distinct instruction sets within context windows and determine which instruction sets align or conflict with each other. Based on decision phase outcomes, the system generates unified outputs by computationally fusing aligned instruction sets and addressing conflicting instruction sets through clarifying queries or consolidated responses.

Technical benefits of multi-user processing include enhanced collaborative efficiency through intelligent conflict resolution, improved group decision-making through systematic input synthesis, reduced communication overhead by providing single unified responses to multiple inputs, and scalable team interaction capabilities that maintain coherence across multiple participants.

The generative AI model underlying these systems may employ transformer-based architecture similar to GPT models, utilizing multi-head self-attention mechanisms for processing both textual and structured data. The architecture may incorporate positional encoding to maintain sequence information, layer normalization and residual connections for stable training and inference, and multimodal processing with separate encoding branches for different data types including text, tabular data, and images. Cross-attention layers enable interaction between different modalities and allow the model to align information from text queries with relevant parts of tabular or image data.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

Implementation of the method and/or system of embodiments of the invention can involve performing or completing selected tasks manually, automatically, or a combination thereof. Moreover, according to actual instrumentation and equipment of embodiments of the method and/or system of the invention, several selected tasks could be implemented by hardware, by software or by firmware or by a combination thereof using an operating system.

For example, hardware for performing selected tasks according to embodiments of the invention could be implemented as a chip or a circuit. As software, selected tasks according to embodiments of the invention could be implemented as a plurality of software instructions being executed by a computer using any suitable operating system. In an exemplary embodiment of the invention, one or more tasks according to exemplary embodiments of method and/or system as described herein are performed by a data processor, such as a computing platform for executing a plurality of instructions. Optionally, the data processor includes a volatile memory for storing instructions and/or data and/or a non-volatile storage, for example, a magnetic hard-disk and/or removable media, for storing instructions and/or data. Optionally, a network connection is provided as well. A display and/or a user input device such as a keyboard or mouse are optionally provided as well.

### BRIEF DESCRIPTION OF THE SEVERAL VIEWS OF THE DRAWING(S)

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIG. 1A is a schematic block diagram illustration of a system for adaptive AI agent with persistent user interface generation, according to some embodiments of the present invention;

FIG. 1B is an exemplary graphical user interface illustration showing a messaging GUI with a dynamically generated stock market widget based on conversational context analysis with an AI agent specialized in stock market analysis, according to some embodiments of the present invention;

FIG. 1C is an exemplary graphical user interface illustration showing a messaging GUI with a dynamically generated calendar widget rendered in a side panel position based on a user's natural language request during a conversational interaction with an AI agent specialized in calendar management, according to some embodiments of the present invention;

FIG. 1D is an exemplary graphical user interface illustration showing the messaging GUI of FIG. 1C with an interactive meeting details card rendered within the message stream responsive to user interaction with the calendar widget, wherein the meeting details card includes editable fields, according to some embodiments of the present invention;

FIG. 1E is an exemplary graphical user interface illustration showing multiple coordinated persistent UI widgets including calendar, gauge, and trend chart widgets for calorie tracking, according to some embodiments of the present invention;

FIG. 1F is an exemplary graphical user interface illustration showing meal planning widgets with visual meal cards organized by meal type categories, according to some embodiments of the present invention;

FIG. 1G is an exemplary graphical user interface illustration showing budget tracking progress bar widgets embedded in conversational message streams for financial management, according to some embodiments of the present invention;

FIG. 2 is a flowchart illustrating a method for generating an adaptive user interface corresponding to the system of FIG. 1A, according to some embodiments of the present invention;

FIG. 3 is a schematic block diagram illustration of a system for processing multi-user inputs to an AI agent, according to some embodiments of the present invention; and

FIG. 4 is a flowchart illustrating a method for processing multi-user inputs to an AI agent corresponding to the system of FIG. 3, according to some embodiments of the present invention.

### DESCRIPTION OF SPECIFIC EMBODIMENTS OF THE INVENTION

The present invention relates to artificial intelligence systems and user interfaces, and more particularly to systems and methods for generating adaptive user interfaces through AI agents that can process conversational inputs and create persistent visual components, as well as handle concurrent multi-user inputs in collaborative environments.

Before describing specific embodiments in detail, it is helpful to understand the overall flow and architecture of the adaptive UI generation system. At a high level, the system enables AI agents to dynamically generate persistent visual interface components based on analysis of conversational patterns, creating a hybrid interaction mode that seamlessly integrates natural language conversation with structured data visualization and manipulation.

The system operates through a continuous cycle: (1) users engage in natural language conversation with AI agents through a messaging interface; (2) the system analyzes the conversational content to identify entities, intents, and patterns that would benefit from visual representation; (3) when appropriate context is detected, the system automatically generates persistent UI widgets configured with data bindings to relevant information; (4) the widgets are rendered as stable visual elements alongside the conversational message stream; (5) users can interact with both the conversational interface and the persistent widgets, with state maintained synchronously between both modalities; and (6) the widgets evolve dynamically as the conversation progresses, with widgets being added, modified, or removed based on changing conversational context.

This architecture addresses fundamental limitations of conventional conversational AI interfaces, which require users to repeatedly request information that could be displayed persistently, force users to maintain information in working memory that could be visualized, and lack mechanisms for direct manipulation of data discussed in conversation. The disclosed system bridges the gap between the flexibility of natural language interaction and the structured control provided by traditional graphical interfaces, enabling users to benefit from both paradigms seamlessly.

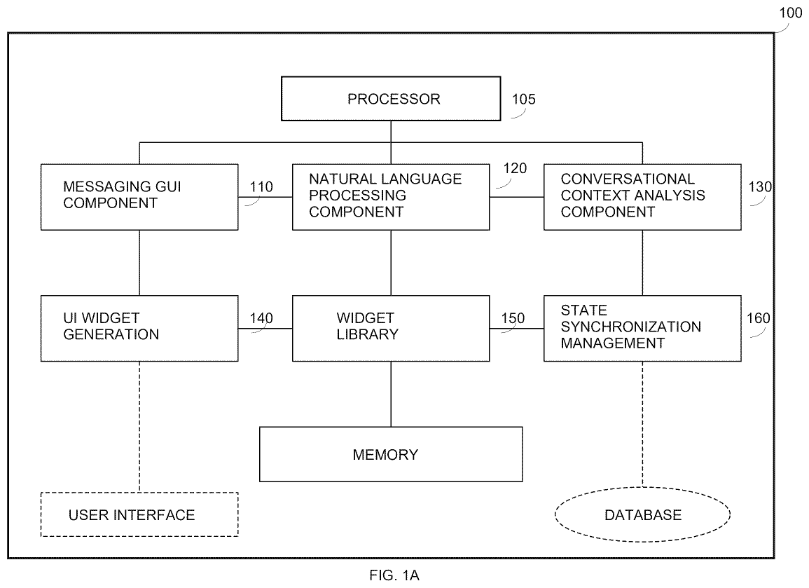

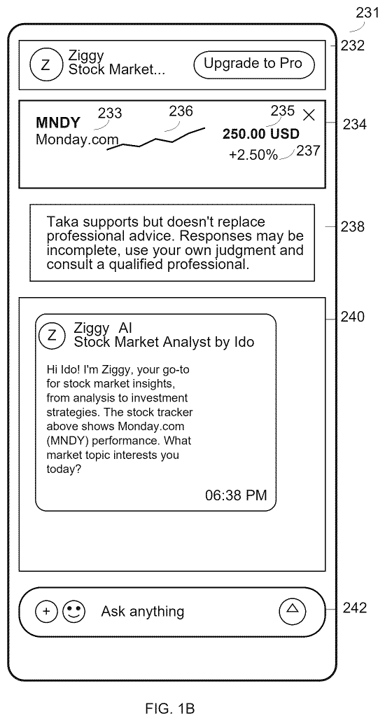

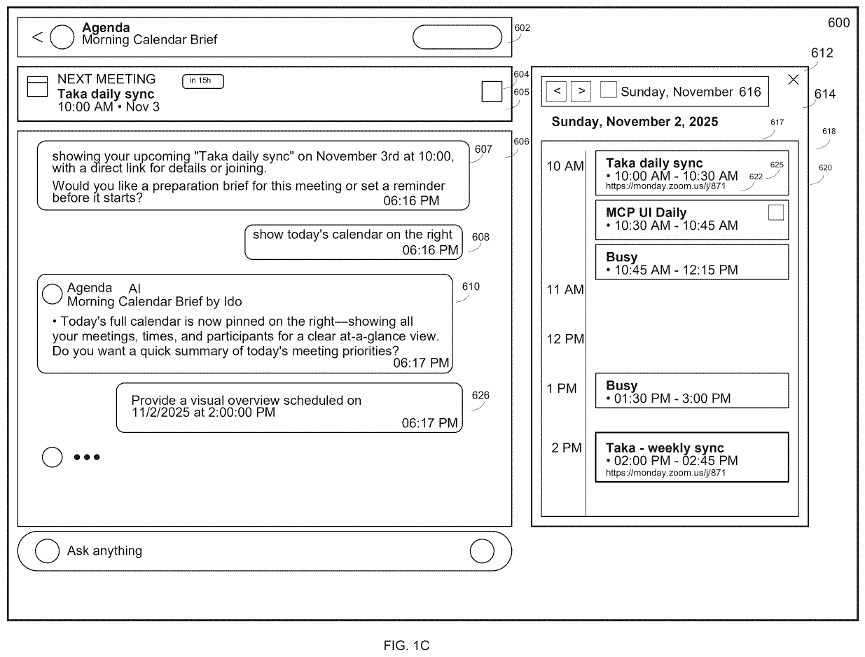

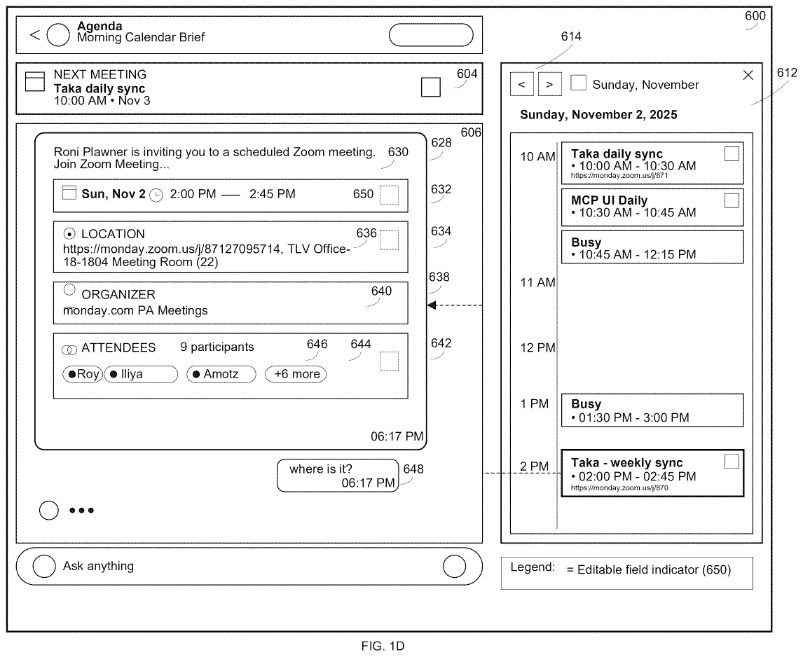

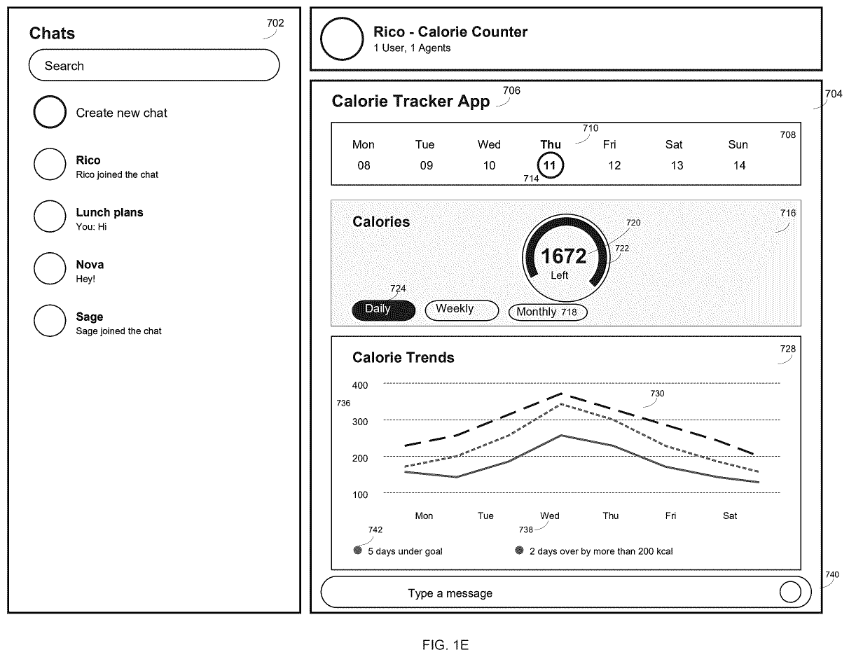

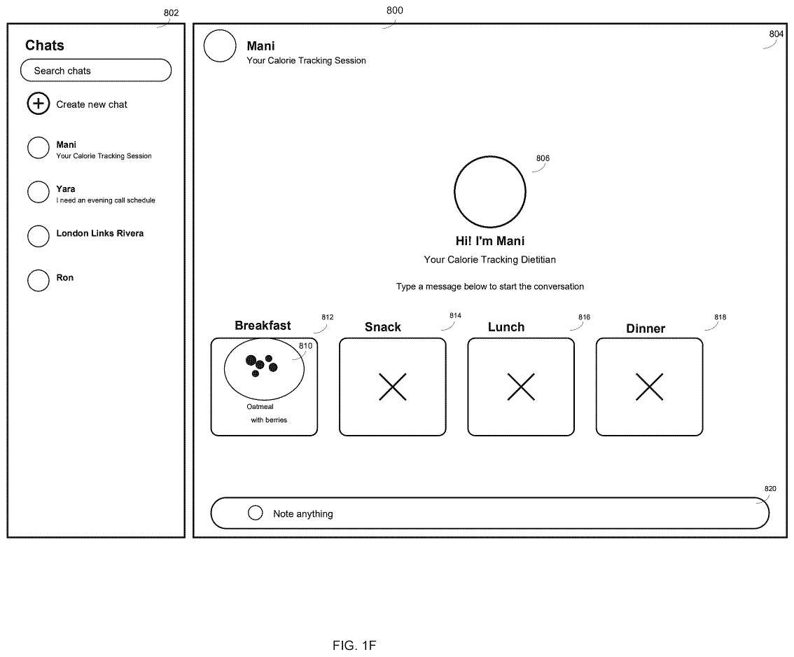

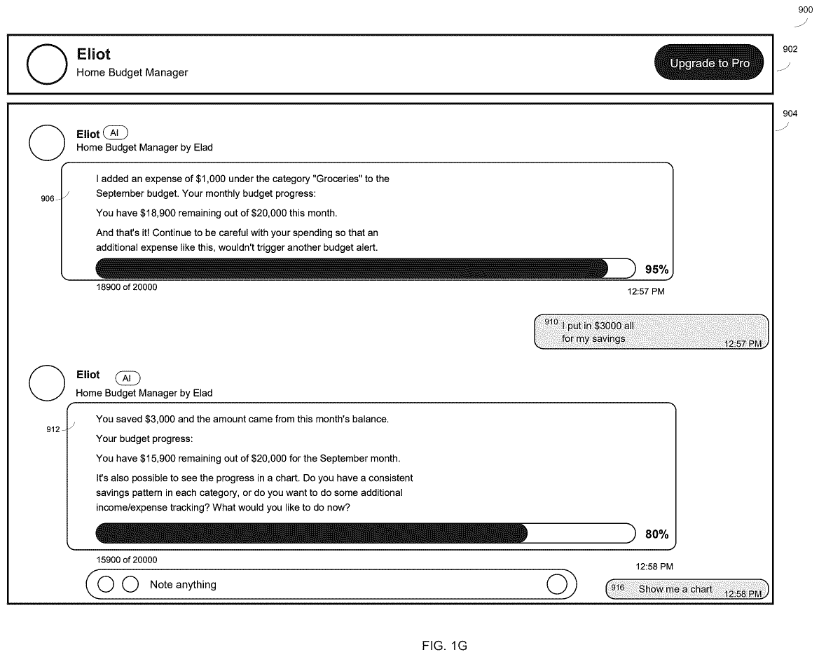

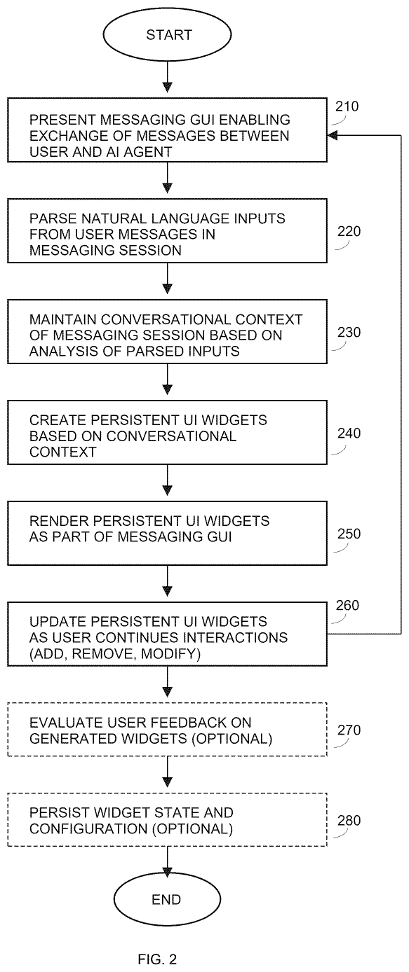

The following detailed description explains the system architecture (FIGS. 1A-1G), illustrates the operational flow (FIG. 2), and provides specific examples of how the system operates across diverse application contexts. Throughout this description, it should be understood that specific implementation details such as particular algorithms, data structures, or numerical thresholds are provided as non-limiting examples to facilitate understanding, and the invention encompasses variations and alternatives to these specific implementations.

As used herein, the following terms have the definitions provided below unless explicitly stated otherwise:

“Persistent UI widget” refers to a graphical user interface component that remains displayed within the messaging GUI across multiple message exchanges and maintains its state and position independent of message stream scrolling. A persistent UI widget differs from transient interface elements (such as pop-up notifications or temporary overlays) that disappear after a predetermined time period or user action. Persistent UI widgets maintain visibility until explicitly dismissed by a user or automatically removed due to changes in conversational context that render the widget no longer relevant.

“Conversational context” refers to a structured data representation of an ongoing conversation that includes: (i) extracted semantic entities and their attributes, (ii) identified user intents and their associated confidence scores, (iii) temporal markers indicating when specific entities or topics were introduced, (iv) relationship graphs connecting mentioned entities, and (v) historical interaction patterns. Conversational context differs from raw message history in that it represents a processed, analyzed state rather than unprocessed text. The conversational context may span multiple messaging sessions and may be stored persistently to enable continuity across session boundaries.

“Context window” for multi-user input processing refers to a time-bounded period during which input messages from multiple users are considered collectively for analysis and response generation. The context window has defined temporal boundaries, with a start time corresponding to receipt of a first message triggering AI agent attention and an end time determined dynamically based on message arrival patterns and detected topic coherence. In some embodiments, context windows may span from 15 seconds to 10 minutes for synchronous conversations, or from 1 minute to 24 hours for asynchronous threaded discussions. Context windows may expand when additional messages arrive that exhibit semantic coherence with the existing window content, and may close when a predetermined silence period elapses or when a detected topic shift occurs.

“Semantic entities” refer to discrete units of meaning extracted from natural language text through named entity recognition and semantic analysis processes. Semantic entities include but are not limited to: person names, organization names, project identifiers, task identifiers, temporal expressions (dates, times, durations), numerical quantities, status indicators, document references, and platform-specific object identifiers. Each semantic entity may be associated with an entity type classification, extracted attribute values, confidence scores indicating extraction certainty, and links to the specific text spans from which the entity was extracted.

“Real-time” and “near real-time” as used in conjunction with data updates refer to update latencies of approximately 50 milliseconds to 5 seconds, which are provided as non-limiting examples. “Real-time” updates typically exhibit latencies below 500 milliseconds, while “near real-time” updates may exhibit latencies between 500 milliseconds and 5 seconds. These thresholds are exemplary and may vary based on network conditions, system load, and the specific data types being updated.

“Unified output” in the multi-user input processing context refers to a single synthesized response generated by computationally analyzing and integrating input messages from multiple distinct users. A unified output differs from multiple individual responses in that it represents a coherent synthesis addressing the collective input rather than separate point-by-point replies to each user.

“Decision phase” refers to the computational process of analyzing multiple input messages to identify distinct instruction sets, determine alignment or conflict relationships between instruction sets, and establish resolution priorities. In some embodiments, the decision phase may include one or more of: (i) extraction of directive statements from each input message, (ii) construction of a pairwise comparison matrix evaluating relationships between all directive pairs, (iii) identification of alignment clusters (groups of directives requesting compatible actions) and conflict clusters (groups of directives requesting incompatible actions), and (iv) assignment of priority weights to conflicting directives based on defined criteria including user roles, temporal ordering, and explicit priority indicators in message content. Other decision phase implementations may employ alternative analytical approaches without departing from the scope of the invention.

“Context score” refers to a numerical value (e.g., scalar, vector, or categorical indicator) representing likelihood of widget utility; may be normalized (e.g., between 0.0 and 1.0) indicating the probability that generating a structured visual interface component (persistent UI widget) would enhance user task completion for the current conversational context. Context scores are computed based on weighted combinations of multiple signals extracted from conversational analysis. Higher context scores (e.g., above 0.7) indicate high probability of widget utility, while lower context scores (e.g., below 0.3) indicate low probability. Context score thresholds for triggering automatic widget generation are configurable and may be adjusted based on user feedback patterns.

“Message stream” refers to a chronologically ordered display region within a messaging graphical user interface that presents conversational messages exchanged between users and AI agent instances during a messaging session. The message stream displays messages in temporal sequence, typically with the most recent messages appearing at the bottom or top of the display region depending on interface convention. The message stream may support scrolling to enable users to navigate through historical messages while continuing to view newly arriving messages. Each message displayed in the message stream may include metadata such as sender identification, timestamp, and message status indicators. The message stream differs from persistent UI widgets in that messages within the stream are transient elements that scroll out of view as new messages arrive, whereas persistent UI widgets maintain fixed visibility independent of message scrolling.

“Widget library” refers to a repository of widget templates organized by functional category and associated with context signatures specifying applicable usage scenarios.

As a non-limiting example of a widget instance schema, a configured widget may be represented using a structured data format such as the following exemplary JSON-like structure (provided for illustration only, not limiting the invention to any particular data format):

```
{
  “widget_id”: “proj_status_dashboard_001”
  “widget_type”: “project_status_dashboard”
  “data_bindings”: {
  “project_entity_id”: “PROJ-2847”,
  “metric_fields”: [“completion_percentage”, “budget_utilization”, “days_remaining”],
  “refresh_policy”: “event_driven”,
  “event_triggers”: [“status_change”, “budget_update”, “timeline_modification”]
  },
  “layout_configuration”: {
  “layout_mode”: “side_panel”,
  “pinned_region”: “right”,
  “width”: “300px”,
  “collapsible”: true
  },
  “provenance_metadata”: {
  “creation_timestamp”: “2025-01-15T14:23:45Z”,
  “triggering_message_id”: “msg_89234”,
  “source_conversation_context_id”: “ctx_45678”,
  “last_modified_timestamp”: “2025-01-15T16:12:33Z”
  },
  “access_scope”: “team_level”,
  “authorized_viewers”: [“team_id_alpha”, “team_id_beta”]
}
```

This exemplary schema illustrates one possible way to structure widget instance data, but the invention is not limited to this particular format or these specific fields. Other data formats including XML, protocol buffers, or proprietary binary formats may alternatively be employed.

Each widget template in the library may include: (i) a declarative specification defining the widget's visual layout and data bindings, (ii) a context signature describing entity types, intent patterns, and data characteristics for which the widget is appropriate, and (iii) configuration parameters enabling customization of the widget's appearance and behavior. The widget library may be extended through addition of new widget templates without requiring modification of the widget generation algorithms.

As described herein below, a generative AI agent may be used herein. Such an agent uses a generative AI model. The generative AI model described herein with reference to any of the figures may be used for enabling interactions with the SaaS platform data and user queries. The architecture may be based on a hybrid approach, combining several advanced machine learning techniques such as transformer-based Architecture, similar to GPT (Generative Pre-trained Transformer) models. Multi-head self-attention mechanisms for processing both textual and structured data may be used, for instance with positional encoding to maintain sequence information in input data and/or layer normalization and residual connections for stable training and inference. Optionally, multimodal processing that incorporates separate encoding branches for different data types (text, tabular data, images) is used. Optionally, byte-pair encoding (BPE) for tokenization is used. Entity embeddings for categorical variables and normalized numerical inputs is used for processing tabular data. A convolutional neural network (CNN) backbone, such as ResNet or EfficientNet is used for analyzing image built from marked area and/or pixels as described below. Cross-attention layers may be added to allow interaction between different modalities and to enable the model to align information from text queries with relevant parts of tabular or image data. Optionally, in multi-interaction process described herein below, a context buffer is maintained to store relevant information from previous interactions. Attention mechanisms may be used to selectively retrieve and apply contextual information. An autoregressive decoder may be used for generating text responses, optionally, with pointer network for referencing specific parts of the input data in responses and/or a mixture of expert modules for specialized outputs (e.g., SQL generation, data visualizations). As used herein the generative AI model may be an outcome of pre-training on large corpus of SaaS platform data and optionally general knowledge bases. Optionally the model is fine-tuned on specific customer datasets and use cases.

Exemplary embodiments are described with reference to the accompanying drawings. The figures are not necessarily drawn to scale. While examples and features of disclosed principles are described herein, modifications, adaptations, and other implementations are possible without departing from the spirit and scope of the disclosed embodiments. Also, the words “comprising,” “having,” “containing,” and “including,” and other similar forms are intended to be equivalent in meaning and be open-ended in that an item or items following any one of these words is not meant to be an exhaustive listing of such item or items, or meant to be limited to only the listed item or items. It should also be noted that as used herein and in the appended claims, the singular forms “a,” “an,” and “the” include plural references unless the context clearly dictates otherwise.

In the following description, various working examples are provided for illustrative purposes. However, is to be understood the present disclosure may be practiced without one or more of these details.

Throughout, this disclosure mentions “disclosed embodiments,” which refer to examples of inventive ideas, concepts, and/or manifestations described herein. Many related and unrelated embodiments are described throughout this disclosure. The fact that some “disclosed embodiments” are described as exhibiting a feature or characteristic does not mean that other disclosed embodiments necessarily share that feature or characteristic.

This disclosure presents various mechanisms for collaborative work systems. Such systems may involve software that enables multiple users to work collaboratively. By way of one example, workflow management software may enable various members of a team to cooperate via a common online platform. It is intended that one or more aspects of any mechanism may be combined with one or more aspects of any other mechanisms, and such combinations are within the scope of this disclosure.

This disclosure is constructed to provide a basic understanding of a few exemplary embodiments with the understanding that features of the exemplary embodiments may be combined with other disclosed features or may be incorporated into platforms or embodiments not described herein while still remaining within the scope of this disclosure. For convenience and form the word “embodiment” as used herein is intended to refer to a single embodiment or multiple embodiments of the disclosure.

Certain embodiments disclosed herein include devices, systems, and methods for collaborative work systems that may allow one or more users to interact with information in real-time. To avoid repetition, the functionality of some embodiments is described herein solely in connection with a processor or at least one processor. It is to be understood that such exemplary descriptions of functionality apply equally to methods and computer-readable media and constitute a written description of systems, methods, and computer-readable media. The underlying platform may allow a user to structure systems, methods, or computer-readable media in many ways using common building blocks, thereby permitting flexibility in constructing a product that suits desired needs. This may be accomplished through the use of boards. A board may be a table configured to contain items (e.g., individual items presented in horizontal rows) defining objects or entities that are managed in the platform (task, project, client, deal, etc.). Unless expressly noted otherwise, the terms “board” and “table” may be considered synonymous for purposes of this disclosure. In some embodiments, a board may contain information beyond what is displayed in a table. For example, a board may further contain cell comments, hidden rows and columns, formulas, data validation rules, filters, specific formatting, audits logs, version history, cross-referencing with different boards, external linking with data sources, permissions of access or a combination thereof. Boards may include sub-boards that may have a separate structure from a board. Sub-boards may be tables with sub-items that may be related to the items of a board. Columns intersecting with rows of items may together define cells in which data associated with each item may be maintained. Each column may have a heading or label defining one or more associated data types and may further include metadata (e.g., definitions, validation rules, ranges, hyperlinks, macros.) . When used herein in combination with a column, a row may be presented horizontally and a column vertically. However, in the broader generic sense as used herein, the term “row” may refer to one or more of a horizontal and/or a vertical presentation. A table or table structure as used herein, refers to data presented in horizontal and vertical rows, (e.g., horizontal rows and vertical columns) defining cells in which data is presented. A table structure may refer to any structure for presenting data in an organized manner, as previously discussed such as cells presented in horizontal rows and vertical columns, vertical rows and horizontal columns, a tree data structure, a web chart, or any other structured representation, as explained throughout this disclosure. A cell may refer to a unit of information contained in the table structure defined by the structure of the table. For example, a cell may be defined as an intersection between a horizontal row with a vertical column in a table structure having rows and columns. A cell may also be defined as an intersection between a horizontal and a vertical row, or as an intersection between a horizontal and a vertical column. As a further example, a cell may be defined as a node on a web chart or a node on a tree data structure. As would be appreciated by a skilled artisan, however, the disclosed embodiments are not limited to any specific structure but rather may be practiced in conjunction with any desired organizational arrangement. In addition, table structure may include any type of information, depending on intended use. As an example, when used in conjunction with a project/task management application, the table structure may include any information associated with one or more tasks, such as one or more status values, projects, time-frames/deadlines, countries, persons, teams, progress statuses, a combination thereof, or any other information related to a task. In some cases, a hierarchy may be established between different items/cells in a same row. For example, a unique identifier (UID) may be assigned to an item and the other cell of the same row may then be associated with the item or the assigned UID.

While a table view may be one way to present and manage the data contained on a board, a tables or board's data may be presented in different ways. For example, in some embodiments, dashboards may be utilized to present or summarize data derived from one or more boards. A dashboard may be a non-table form of presenting data, using, for example, static or dynamic graphical representations. A dashboard may also include multiple non-table forms of presenting data. As discussed later in greater detail, such representations may include various forms of graphs or graphics (which may also be referred to more generically as “widgets”). In some instances, dashboards may also include table structure. Software links may interconnect one or more boards with one or more dashboards thereby enabling the dashboards to reflect data presented on the boards. This may allow, for example, data from multiple boards to be displayed and/or managed from a common location. These widgets may provide visualizations that allow a user to update data derived from one or more boards.

Boards (or the data associated with boards) may be stored in a local memory on a user device or may be stored in a local network repository. Boards may also be stored in a remote repository and may be accessed through a network. In some instances, permissions may be set to limit board access to the board's “owner” while in other embodiments a user's board may be accessed by other users through any of the networks described in this disclosure. In alternative scenarios, permission may not only be provided at the board level, but also at a more granular level such as rows, columns, and even individual cells, allowing for fine-grained control over who may access, view, edit, or interact with the data included in the board, particularly useful when dealing with collaborative boards. When one user makes a change in a board, that change may be updated to the board stored in a memory or repository and may be pushed to the other user devices that access that same board. These changes may be made to cells, items, columns, boards, dashboard views, logical rules, or any other data associated with the boards. Similarly, when cells are tied together or are mirrored across multiple boards, a change in one board may cause a cascading change in the tied or mirrored boards or dashboards of the same or other owners.

Boards and widgets may be part of a platform that may enable users to interact with information in real-time in collaborative work systems involving electronic collaborative word-processing documents. Electronic collaborative word processing documents (and other variations of the term) as used herein are not limited to only digital files for word processing but may include any other processing document such as presentation slides, tables, databases, graphics, sound files, video files or any other digital document or file. Electronic collaborative word processing documents may include any digital file that may provide for input, editing, formatting, display, and/or output of text, graphics, widgets, objects, tables, links, animations, dynamically updated elements, or any other data object that may be used in conjunction with the digital file. Any information stored on or displayed from an electronic collaborative word processing document may be organized into blocks. A block may include any organizational unit of information in a digital file, such as a single text character, word, sentence, paragraph, page, graphic, or any combination thereof. Blocks may include static or dynamic information and may be linked to other sources of data for dynamic updates. Blocks may be automatically organized by the system or may be manually selected by a user according to preference. In one embodiment, a user may select a segment of any information in an electronic word-processing document and assign it as a particular block for input, editing, formatting, or any other further configuration.

An electronic collaborative word-processing document may be stored in one or more repositories connected to a network accessible by one or more users through their computing devices. In one embodiment, one or more users may simultaneously edit an electronic collaborative word-processing document. The one or more users may access the electronic collaborative word-processing document through one or more user devices connected to a network. User access to an electronic collaborative word processing document may be managed through permission settings set by an author of the electronic collaborative word processing document. Alternatively, permissions to specific portions of the electronic collaborative word-processing document may be provided in order to control access, facilitate collaboration, and ensure that different users have appropriate levels of involvement and authority over different parts of the content. An electronic collaborative word-processing document may include graphical user interface elements enabled to support the input, display, and management of multiple edits made by multiple users operating simultaneously within the same document.

Various embodiments are described herein with reference to a system, method, device, or computer readable medium. It is intended that the disclosure of one is a disclosure of all. For example, it is to be understood that disclosure of a computer-readable medium described herein also constitutes a disclosure of methods implemented by the computer-readable medium, and systems and devices for implementing those methods, via for example, at least one processor. It is to be understood that this form of disclosure is for case of discussion only, and one or more aspects of one embodiment herein may be combined with one or more aspects of other embodiments herein, within the intended scope of this disclosure.

Embodiments described herein may refer to a non-transitory computer-readable medium containing instructions that when executed by at least one processor, cause the at least one processor to perform a method. Non-transitory computer readable mediums may be any medium capable of storing data in any memory in a way that may be read by any computing device with a processor to carry out methods or any other instructions stored in the memory. The non-transitory computer readable medium may be implemented as hardware, firmware, software, or any combination thereof. Moreover, the software may preferably be implemented as an application program tangibly embodied on a program storage unit or computer readable medium consisting of parts, or of certain devices and/or a combination of devices. The application program may be uploaded to, and executed by, a machine comprising any suitable architecture. Preferably, the machine may be implemented on a computer platform having hardware such as one or more central processing units (“CPUs”), a memory, and input/output interfaces. The computer platform may also include an operating system and microinstruction code. The various processes and functions described in this disclosure may be either part of the microinstruction code or part of the application program, or any combination thereof, which may be executed by a CPU, whether or not such a computer or processor is explicitly shown. In addition, various other peripheral units may be connected to the computer platform such as an additional data storage unit and a printing unit. Furthermore, a non-transitory computer readable medium may be any computer readable medium except for a transitory propagating signal.

As used herein, a non-transitory computer-readable storage medium refers to any type of physical memory on which information or data readable by at least one processor can be stored. Examples of memory include Random Access Memory (RAM), Read-Only Memory (ROM), volatile memory, nonvolatile memory, hard drives, CD ROMs, DVDs, flash drives, disks, any other optical data storage medium, any physical medium with patterns of holes, markers, or other readable elements, a PROM, an EPROM, a FLASH-EPROM or any other flash memory, NVRAM, a cache, a register, any other memory chip or cartridge, and networked versions of the same. The terms “memory” and “computer-readable storage medium” may refer to multiple structures, such as a plurality of memories or computer-readable storage mediums located within an input unit or at a remote location. Additionally, one or more computer-readable storage mediums can be utilized in implementing a computer-implemented method. The memory may include one or more separate storage devices collocated or disbursed, capable of storing data structures, instructions, or any other data. The memory may further include a memory portion containing instructions for the processor to execute. The memory may also be used as a working scratch pad for the processors or as temporary storage. Accordingly, the term computer-readable storage medium should be understood to include tangible items and exclude carrier waves and transient signals.

Some embodiments may involve at least one processor. Consistent with disclosed embodiments, “at least one processor” may constitute any physical device or group of devices having electric circuitry that performs a logic operation on an input or inputs. For example, the at least one processor may include one or more integrated circuits (IC), including application-specific integrated circuits (ASIC), microchips, microcontrollers, microprocessors, all or part of a central processing unit (CPU), graphics processing unit (GPU), digital signal processor (DSP), field-programmable gate array (FPGA), server, virtual server, or other circuits suitable for executing instructions or performing logic operations. The instructions executed by at least one processor may, for example, be pre-loaded into a memory integrated with or embedded into the controller or may be stored in a separate memory. The memory may include a Random Access Memory (RAM), a Read-Only Memory (ROM), a hard disk, an optical disk, a magnetic medium, a flash memory, other permanent, fixed, or volatile memory, or any other mechanism capable of storing instructions. In some embodiments, the at least one processor may include more than one processor. Each processor may have a similar construction, or the processors may be of differing constructions that are electrically connected or disconnected from each other. For example, the processors may be separate circuits or integrated into a single circuit. When more than one processor is used, the processors may be configured to operate independently or collaboratively and may be co-located or located remotely from each other. The processors may be coupled electrically, magnetically, optically, acoustically, mechanically, or by other means that permit them to interact.

Consistent with the present disclosure, disclosed embodiments may involve a network. A network may constitute any type of physical or wireless computer networking arrangement used to exchange data. For example, a network may be the Internet, a private data network, a virtual private network using a public network, a Wi-Fi network, a LAN or WAN network, a combination of one or more of the foregoing, and/or other suitable connections that may enable information exchange among various components of the system. In some embodiments, a network may include one or more physical links used to exchange data, such as Ethernet, coaxial cables, twisted pair cables, fiber optics, or any other suitable physical medium for exchanging data. A network may also include a public switched telephone network (“PSTN”) and/or a wireless cellular network. A network may be a secured network or an unsecured network. In other embodiments, one or more components of the system may communicate directly through a dedicated communication network. Direct communications may use any suitable technologies, including, for example, BLUETOOTH™, BLUETOOTH LE™ (BLE), Wi-Fi, near-field communications (NFC), or other suitable communication methods that provide a medium for exchanging data and/or information between separate entities.

Certain embodiments disclosed herein may also include a computing device for generating features for work collaborative systems, the computing device may include processing circuitry communicatively connected to a network interface and to a memory, wherein the memory contains instructions that, when executed by the processing circuitry, configure the computing device to receive from a user device associated with a user account instruction to generate a new column of a single data type for a first data structure, wherein the first data structure may be a column-oriented data structure, and store, based on the instructions, the new column within the column-oriented data structure repository, wherein the column-oriented data structure repository may be accessible and may be displayed as a display feature to the user and at least a second user account. The computing devices may be devices such as mobile devices, desktops, laptops, tablets, or any other devices capable of processing data. Such computing devices may include a display such as an LED display, augmented reality (AR), or virtual reality (VR) display.

Disclosed embodiments may include and/or access a data structure. A data structure consistent with the present disclosure may include any collection of data values and relationships among them. The data may be stored linearly, horizontally, hierarchically, relationally, non-relationally, uni-dimensionally, multi-dimensionally, operationally, in an ordered manner, in an unordered manner, in an object-oriented manner, in a centralized manner, in a decentralized manner, in a distributed manner, in a custom manner, or in any manner enabling data access. By way of non-limiting examples, data structures may include an array, an associative array, a linked list, a binary tree, a balanced tree, a heap, a stack, a queue, a set, a hash table, a record, a tagged union, ER model, and a graph. For example, a data structure may include an XML database, an RDBMS database, an SQL database, or NoSQL alternatives for data storage/search such as MongoDB, Redis, Couchbase, Datastax Enterprise Graph, Elastic Search, Splunk, Solr, Cassandra, Amazon DynamoDB, Scylla, HBase, and Neo4J. A data structure may be a component of the disclosed system or a remote computing component (e.g., a cloud-based data structure). Data in the data structure may be stored in contiguous or non-contiguous memory. Moreover, a data structure, as used herein, does not require information to be co-located. It may be distributed across multiple servers, for example, that may be owned or operated by the same or different entities. Thus, the term “data structure” as used herein in the singular is inclusive of plural data structures.

Certain embodiments disclosed herein may include a processor configured to perform methods that may include triggering an action in response to an input. The input may be from a user action or from a change of information contained in a user's table or board, in another table, across multiple tables, across multiple user devices, or from third-party applications. Triggering may be caused manually, such as through a user action, or may be caused automatically, such as through a logical rule, logical combination rule, or logical templates associated with a board. For example, a trigger may include an input of a data item that is recognized by at least one processor that brings about another action.

In some embodiments, the methods including triggering may cause an alteration of data and may also cause an alteration of display of data with different levels of granularity (e.g., a specific board, a plurality of boards.) or across an entirety of an account or entity (e.g., multiple boards, workspaces, or projects within the account). An alteration of data may include a recalculation of data, the addition of data, the subtraction of data, or a rearrangement of information. Further, triggering may also cause a communication to be sent to a user, other individuals, or groups of individuals. The communication may be a notification within the system or may be a notification outside of the system through a contact address such as by email, phone call, text message, video conferencing, or any other third-party communication application.

Some embodiments include one or more automations, logical rules, logical sentence structures, and logical (sentence structure) templates. While these terms are described herein in differing contexts, in the broadest sense, in each instance an automation may include a process that responds to a trigger or condition to produce an outcome; a logical rule may underly the automation in order to implement the automation via a set of instructions; a logical sentence structure is one way for a user to define an automation; and a logical template/logical sentence structure template may be a fill-in-the-blank tool used to construct a logical sentence structure. While all automations may have an underlying logical rule, all automations need not implement that rule through a logical sentence structure. Any other manner of defining a process that responds to a trigger or condition to produce an outcome may be used to construct an automation.

Other terms used throughout this disclosure in differing exemplary contexts may generally share the following common definitions.

In some embodiments, machine learning algorithms (also referred to as machine learning models or artificial intelligence in the present disclosure) may be trained using training examples, for example in the cases described below. Some non-limiting examples of such machine learning algorithms may include classification algorithms, data regressions algorithms, image segmentation algorithms, visual detection algorithms (such as object detectors, face detectors, person detectors, motion detectors, edge detectors, etc.), visual recognition algorithms (such as face recognition, person recognition, object recognition, etc.), speech recognition algorithms, mathematical embedding algorithms, NLP algorithms, support vector machines, random forests, nearest neighbors algorithms, deep learning algorithms, artificial neural network algorithms, convolutional neural network algorithms, recursive neural network algorithms, linear machine learning models, non-linear machine learning models, ensemble algorithms, and so forth. For example, a trained machine learning algorithm may include an inference model, such as a predictive model, a classification model, a regression model, a clustering model, a segmentation model, an artificial neural network (such as a deep neural network, a convolutional neural network, a recursive neural network, etc.), a random forest, a support vector machine, and so forth. In some examples, the training examples may include example inputs together with the desired outputs corresponding to the example inputs. Further, in some examples, training machine learning algorithms using the training examples may generate a trained machine learning algorithm, and the trained machine learning algorithm may be used to estimate outputs for inputs not included in the training examples. In some examples, engineers, scientists, processes, and machines that train machine learning algorithms may further use validation examples and/or test examples. For example, validation examples and/or test examples may include example inputs together with the desired outputs corresponding to the example inputs, a trained machine learning algorithm and/or an intermediately trained machine learning algorithm may be used to estimate outputs for the example inputs of the validation examples and/or test examples, the estimated outputs may be compared to the corresponding desired outputs, and the trained machine learning algorithm and/or the intermediately trained machine learning algorithm may be evaluated based on a result of the comparison. In some examples, a machine learning algorithm may have parameters and hyperparameters, where the hyperparameters are set manually by a person or automatically by a process external to the machine learning algorithm (such as a hyperparameter search algorithm), and the parameters of the machine learning algorithm are set by the machine learning algorithm according to the training examples. In some implementations, the hyper-parameters are set according to the training examples and the validation examples, and the parameters are set according to the training examples and the selected hyper-parameters.

Project management platforms are digital tools or software designed to streamline and automate various processes within an organization. They help to coordinate and manage tasks, activities, and information flow among several team members or different departments, ensuring efficient collaboration and productivity. These platforms may provide features such as task assignment, progress tracking, notifications, and document management. In some cases, these platforms may correspond to a Software-as-a-Service (SaaS) platform. Within the context of this disclosure, a SaaS platform may refer to any kind of cloud-based software delivery model where service providers host software applications and make them accessible to users over the Internet. Instead of installing, managing, and maintaining the software locally, users access and utilize it through a web browser or thin client interface.

SaaS platforms offer a wide range of applications and services to meet various business needs such as customer relationship management (CRM), human resources management (HRM), project management, accounting, marketing automation, and more. In most scenarios, these platforms operate on a subscription basis, with customers paying recurring fees for software access and usage. SaaS platforms may provide several advantages including:
Accessibility: Users may conveniently and securely access software and data from any device with an internet connection.
Scalability: SaaS platforms may easily scale up or down to accommodate changing business requirements, providing flexibility and cost-effectiveness.
Cost-effectiveness: By eliminating upfront investments in hardware and software, SaaS may reduce initial costs. Customers may pay subscription fees based on their usage.
Maintenance and Updates: Service providers handle software maintenance, updates, and security patches, relieving customers of these responsibilities.
Collaboration: SaaS platforms often offer collaboration features, enabling multiple users to work together, share data, and communicate within the platform.
Customization: SaaS platforms can offer a high level of customization, allowing businesses to tailor the software to their specific needs. These applications can be seamlessly integrated with other business applications, particularly those offered by the same software provider. This integration enables smooth data flow and collaboration between different software systems, enhancing overall productivity and efficiency.

Some examples of SaaS platforms include Monday.com™ for project management, Salesforce™ for CRM, Slack™ for team collaboration, Dropbox™ for file hosting and sharing, Microsoft365™ for productivity tools, Google Workspace™ apps for productivity and collaboration tools, Zendesk™ for customer support, HubSpot™ for marketing, and Shopify™ for e-commerce.

SaaS platforms may include a plurality of SaaS platform elements which may correspond to components or building blocks of the platform that work together to deliver software applications and services over the Internet. Examples of such elements may include application software, infrastructure, or user interface. For example, a platform may offer project management capabilities to its users via dashboards, tables, text documents, a workflow manager, diverse applications offered on a marketplace, all of which constitute building blocks and therefore elements of the platform. Application offered on the marketplace may be provided by developers external to the SaaS platform, accordingly, they may utilize a user interface different from a generic user interface provided by the SaaS platform. In addition, each SaaS platform element may include a plurality of SaaS platform sub-elements which may refer to smaller components or features that are part of a larger element within a SaaS platform. These sub-elements may be designed to perform specific tasks or provide specialized functionality. The collaboration of multiple sub-elements aims to create a and integrated SaaS solution. Examples of SaaS platform sub-element may include a widget associated with a dashboard, a column or a cell associated with a table, a workflow block associated with a workflow manager, or management tools. As used herein a SaaS platform element is A discrete component or building block within a SaaS platform that provides specific functionality or serves a particular purpose. These elements can include, but are not limited to, tables, dashboards, workflows, text documents, and applications available through a marketplace. SaaS platform elements can be combined or customized to create tailored solutions within the platform.

The present invention relates to artificial intelligence systems and user interfaces, and more particularly to systems and methods for generating adaptive user interfaces through AI agents that can process conversational inputs and create persistent visual components, as well as handle concurrent multi-user inputs in collaborative environments.

Before explaining at least one embodiment of the invention in detail, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.

The systems and methods disclosed herein may optionally be implemented within a distributed SaaS platform architecture that comprises server-side processing infrastructure and client-side rendering components. In some embodiments, the server-side infrastructure may include one or more application servers executing the AI agent logic, database systems storing user data and conversational context, message brokers facilitating real-time communication between system components, and inference servers hosting the trained AI models. The client-side components may optionally include web browser-based applications, native mobile applications for iOS and Android platforms, and desktop applications that render the messaging GUI and persistent UI widgets.

In optional implementations, the server-side infrastructure may be deployed across multiple geographic regions using cloud computing platforms such as Amazon Web Services, Google Cloud Platform, or Microsoft Azure. Load balancing mechanisms may optionally distribute incoming requests across multiple application server instances to maintain responsiveness during periods of high user activity. The application servers may communicate with database clusters using connection pooling to optimize resource utilization. Message queuing systems such as Apache Kafka or RabbitMQ may optionally facilitate asynchronous processing of AI inference requests and real-time event propagation to connected clients.

In one optional implementation, the server infrastructure may maintain WebSocket connections with each connected client device, enabling bidirectional real-time communication. When the AI agent generates or updates a persistent UI widget, the server may transmit widget state updates through the WebSocket connection to all relevant client devices. The client-side application may receive the widget state update and render the corresponding visual components using the platform's UI framework. This architecture may optionally ensure that widget updates propagate to all connected devices associated with a user account with minimal latency, typically within 50 to 200 milliseconds depending on network conditions.

The SaaS platform may optionally organize user data within a hierarchical structure comprising accounts, workspaces, boards, and items. An account may represent an organization or individual subscription. Workspaces may group related boards and users within an account. Boards may contain structured data organized in rows (items) and columns, with each column optionally defining a data type such as text, numbers, dates, status values, or relationships to other items. Items may represent individual records within a board, such as tasks, projects, clients, or any other entity being managed.

The conversational context maintained by the AI agent system may optionally reference entities within this hierarchical data structure. When parsing natural language inputs, the system extracts entity references that may correspond to specific accounts, workspaces, boards, items, or columns. The extracted entity references may enable the AI agent to generate persistent UI widgets that display and manipulate data from the referenced entities. For example, when a user discusses project progress in a messaging session, the AI agent may optionally identify references to specific project items and generate a status tracking widget that displays completion percentages derived from status column values associated with those items.

Reference is now made to FIG. 1A, which is a schematic illustration of a system for adaptive AI agent with persistent UI generation. The system 100 comprises one or more processors, referred to herein as processor 105, which executes a messaging GUI component 110, natural language processing code instructions 120, conversational context analysis code instructions 130, UI widget generation code instructions 140, and may optionally include a widget library 150 and a state synchronization management component 160. Optional components 150 and 160 are shown in dashed lines in FIG. 1A to indicate their optional nature.

The processor 105 may optionally comprise one or more central processing units (CPUs) for general-purpose computation, graphics processing units (GPUs) optimized for parallel inference operations, tensor processing units (TPUs) or other application-specific integrated circuits (ASICs) designed for machine learning workloads, or field-programmable gate arrays (FPGAs) configured for specific processing patterns. In optional distributed deployments, the processor 105 may span multiple physical or virtual server instances operating as a coordinated processing cluster.

The messaging GUI component 110 generates user interface specifications that are transmitted to client devices for rendering. The specifications may optionally be formatted using standard web technologies including HTML5 for document structure, CSS3 for visual styling, and JavaScript for client-side interactivity. Alternatively, the specifications may optionally be formatted using platform-specific native UI frameworks for iOS (UIKit or SwiftUI) or Android (Android Views or Jetpack Compose) when native mobile applications are used. The messaging GUI component 110 may optionally implement responsive design principles to adapt the interface layout to varying screen sizes and orientations across desktop, tablet, and mobile device form factors.

In some optional embodiments, a widget library 150 may maintain a repository of widget templates organized by functional category. Categories may optionally include data visualization widgets (charts, graphs, sparklines, heat maps), status tracking widgets (progress bars, stage indicators, health indicators), data table widgets (sortable and filterable tabular displays), input collection widgets (forms, surveys, approval interfaces), navigation widgets (breadcrumbs, quick access panels), and notification widgets (alerts, banners, toast messages). Each widget template may optionally include metadata describing its applicable context types, required data bindings, optional configuration parameters, and behavioral characteristics.

The messaging GUI component 110 instructs web applications, client side software or components or any other frontstage software to present an interface enabling exchange of messages between users and AI agent instances, such as a messaging application or messaging add-on application. The messaging GUI comprises a message stream display area and may optionally include persistent widget display areas. The natural language processing component 120 receives user messages from the messaging GUI and parses natural language inputs using techniques that may optionally include entity extraction, intent classification, and semantic analysis.

The conversational context analysis component 130 maintains conversational context of messaging sessions based on analysis of parsed natural language inputs. The component may optionally identify recurring interaction patterns, extract semantic entities from natural language inputs, and assign context scores indicating probability that structured visualization would enhance user task completion. In some embodiments, the context analysis engine may employ transformer-based architecture with multi-head self-attention mechanisms for processing both textual and structured data, optionally utilizing positional encoding to maintain sequence information in input data.

The conversational context analysis component 130 may compute context scores indicating the probability that structured visualization would enhance user task completion. In one exemplary embodiment (provided as a non-limiting example), the context score may be calculated according to the following formula:

Context_Score=(Entity_Frequency×W1)+(Quantitative_Data_Presence×W2)+(Trend_Intent_Detection×W3)+(Tracking_Language_Detection×W4)+(Historical_Benefit_Pattern×W5)

Where (all thresholds and coefficients provided as non-limiting examples; other values may be used):
Entity_Frequency is a normalized value between 0.0 and 1.0 representing how frequently specific entities are referenced (computed as: mentions_of_entity/total_messages, capped at 1.0)
Quantitative_Data_Presence is a binary value (0.0 or 1.0) indicating whether numerical or quantitative data has been discussed
Trend_Intent_Detection is a confidence score (0.0 to 1.0) from the intent classifier indicating presence of comparison or trend analysis intents
Tracking_Language_Detection is a binary value (0.0 or 1.0) indicating presence of monitoring or status-tracking language patterns
Historical_Benefit_Pattern is a normalized value (0.0 to 1.0) based on whether similar contexts previously benefited from widget generation for this user
W1 through W5 are weight coefficients summing to 1.0

In one specific example implementation, the weight coefficients may be set as follows (provided as non-limiting examples; other coefficient values may be used): W1=0.25, W2=0.20, W3=0.25, W4=0.15, W5=0.15. Other formulations, weightings, and scoring mechanisms may alternatively be employed without departing from the scope of the invention.

Worked Example: Consider a conversational context where a user has discussed “Project Alpha” in 4 out of the last 5 messages, mentioned specific numerical metrics (budget: $50,000, completion: 65%), expressed intent to “track progress over time,” and used language such as “monitor status” and “keep an eye on.” The user's historical interaction patterns show previous positive engagement with project tracking widgets (feedback score of 0.8).

The context score calculation proceeds as follows: Entity_Frequency=4/5=0.80 Quantitative_Data_Presence=1.0 (numerical metrics are present) Trend_Intent_Detection=0.85 (intent classifier confidence for trend analysis) Tracking_Language_Detection=1.0 (monitoring language detected) Historical_Benefit_Pattern=0.80 (from user feedback history)

Context_Score=(0.80×0.25)+(1.0×0.20)+(0.85×0.25)+(1.0×0.15)+(0.80×0.15) Context_Score=0.20+0.20+0.21+0.15+0.12 Context_Score=0.88

With a configured threshold of 0.70 for automatic widget generation, this context score of 0.88 exceeds the threshold, triggering the UI widget generation component 140 to create a project tracking widget displaying Project Alpha's status, budget utilization, and completion percentage.

The UI widget generation component 140 creates persistent UI widgets based on conversational context. The component may optionally select widgets from widget library 150 based on context scores exceeding predetermined thresholds or may generate widgets using suitable generative AI models based on the respective chat content. Each persistent UI widget may be programmatically configured with data bindings linked to extracted semantic entities. The widget library 150 may optionally contain various widget types including data visualization widgets, charts, status trackers, project tracking widgets, metric dashboards, and control panels.

In some optional embodiments, the UI widget generation component 140 may implement a two-phase process for creating persistent UI widgets. The first phase may perform widget type selection, and the second phase may perform widget configuration and data binding.

During optional widget type selection, the system may evaluate the current conversational context against a library of widget templates. Each widget template may optionally be associated with a context signature that specifies the entity types, intent patterns, and data characteristics for which the widget is appropriate. The system may compute a match score between the current context and each template's context signature using a learned scoring function. Templates with match scores exceeding a configurable threshold may be considered as candidates for widget generation. When multiple templates exceed the threshold, the system may optionally present options to the user or select the template with the highest match score.

Widget templates in the widget library 150 may optionally be defined using a declarative specification language that describes the widget's visual layout, data bindings, interaction handlers, and update triggers. The specification language may support composition of primitive visual elements including text labels, numerical displays, progress bars, sparkline charts, bar charts, pie charts, tables, status indicators, user avatars, date pickers, dropdown selectors, and action buttons. Layout primitives may optionally enable arrangement of visual elements in rows, columns, grids, and stacked configurations with configurable spacing and alignment.

During optional widget configuration, the system may instantiate a widget template by binding template parameters to values derived from the conversational context. Data bindings may link widget visual elements to data sources, which may optionally include entity attributes from the entity registry, aggregations computed over sets of entities, real-time values retrieved from platform data sources, or synthesized values computed by the AI agent. Each data binding may optionally specify a refresh policy that determines when the binding is re-evaluated: on-demand (when the user explicitly requests refresh), polling-based (at fixed time intervals), event-driven (when relevant platform events occur), or context-driven (when the conversational context changes).

In some embodiments, the widget rendering process may differ between server-side rendering and client-side rendering modes. In optional server-side rendering mode, the application server may generate complete HTML and CSS representations of widgets and transmit these representations to client devices for display. In optional client-side rendering mode, the server may transmit widget specifications in a structured format (such as JSON) and the client-side application may render the visual representation using native UI components. Client-side rendering may enable smoother animations and interactions but may require more capable client devices. The system may optionally and adaptively select rendering mode based on detected client capabilities and network conditions.

Widget positioning within the messaging GUI may optionally be determined by a layout engine that allocates screen real estate between the message stream and persistent widgets. The layout engine may support multiple arrangement modes including side-by-side mode (widgets displayed in a panel adjacent to the message stream), overlay mode (widgets displayed as floating panels that can be repositioned by the user), and inline mode (widgets displayed at specific positions within the message stream). In optional side-by-side and overlay modes, widgets may remain visually fixed regardless of message stream scrolling, ensuring persistent visibility during extended conversations.

In alternative embodiments, the persistent UI widgets may be rendered in a dedicated dashboard that is maintained separately from but synchronized with the chat interface. The dedicated dashboard may be displayed in a separate browser tab, a separate window, or a separate panel within the application interface that does not share screen real estate with the messaging GUI. When operating in dedicated dashboard mode, the state synchronization management component 160 maintains bidirectional synchronization between the conversational interface and the dashboard-rendered widgets. Conversational inputs that reference entities displayed in dashboard widgets trigger automatic updates to the dashboard display, while user interactions with dashboard widgets generate corresponding updates to the conversational context. The dedicated dashboard mode may be particularly beneficial for users working with multiple monitors or for scenarios requiring sustained visibility of complex widget arrays while maintaining a separate conversational workspace. Users may optionally toggle between integrated panel display mode and dedicated dashboard mode based on their workspace configuration preferences.

In some optional embodiments, a state synchronization management component 160 may maintain coordination between conversational and widget-based interactions. The manager may automatically update widget displays when relevant information is provided through the chat interface and may reflect widget-based actions in conversational context for AI agent awareness.

The system renders persistent UI widgets as part of the messaging GUI. In optional embodiments, the persistent UI widgets may remain visually fixed within the messaging GUI independent of scrolling message streams and may persist across multiple user sessions. The system may optionally enable hybrid interaction wherein users can seamlessly alternate between issuing natural language commands through chat interfaces and performing structured operations through persistent UI widgets.

In some optional embodiments, the hybrid interaction mode may enable users to seamlessly alternate between natural language conversation and structured widget interactions while maintaining full contextual awareness across both modalities. This capability may address a significant limitation of conventional conversational interfaces, which typically require users to express all inputs through natural language even when structured inputs would be more efficient.

When a user interacts with a persistent UI widget (for example, by selecting a value from a dropdown menu, clicking an action button, or modifying a displayed value), the widget interaction may optionally be captured by the client-side application and transmitted to the server as a structured event. The event may include the widget identifier, the interaction type (selection, modification, button click, etc.), the interaction parameters (selected value, modified field, button identifier, etc.), and contextual information such as the timestamp and the user's client device.

In some embodiments, the state synchronization manager may receive the widget interaction event and perform two parallel operations. First, the manager may update the underlying data sources to reflect the widget interaction (for example, updating a database record to reflect a changed status value). Second, the manager may generate a synthetic conversational event that represents the widget interaction in natural language form. This synthetic event may optionally be injected into the conversational context maintained by the AI agent, enabling the agent to maintain awareness of widget interactions as part of the overall conversation history.

The synthetic conversational event may optionally be rendered in the message stream as a system message that describes the widget interaction (for example, “Alex changed the status to Complete”). This rendering may provide transparency to other conversation participants about widget-driven changes. The visibility of these system messages may optionally be controlled by user preferences or organizational policies.

When the user subsequently sends a natural language message that references the widget interaction (for example, “Now that I've marked that complete, what's next?”), the AI agent's context may include both the explicit natural language message and the synthetic event representing the prior widget interaction. This unified context may enable the agent to respond appropriately without requiring the user to re-state information that was already expressed through the widget interaction.

Conversely, when the AI agent detects that a natural language message describes a change that could be effected through an existing widget, the agent may optionally suggest or automatically trigger the corresponding widget update. For example, if a user writes “Let's move the deadline to next Friday” and a calendar widget is displaying the task deadline, the agent may update the calendar widget to reflect the new deadline while also acknowledging the change in the conversational response.

In optional embodiments, the state synchronization component 160 may maintain consistency between the conversational interface and the persistent UI widgets through bidirectional synchronization protocols. When users interact with the conversational interface by sending messages that reference entities displayed in widgets, the state synchronization manager may detect the entity references and trigger widget updates if the message content indicates changed entity state. Conversely, when users interact directly with widgets (for example, by changing a status value through a dropdown selector), the state synchronization manager may record the interaction, update the underlying data sources, and optionally generate a conversational acknowledgment message that appears in the message stream.

The synchronization protocol may optionally employ concurrency control to handle concurrent modifications from multiple sources. Each widget state update may include a version identifier that enables detection of conflicting modifications. When a conflict is detected (for example, when a user modifies a widget value while a background synchronization process is updating the same value based on external data), the system may apply configurable conflict resolution policies. Resolution policies may optionally include last-writer-wins (most recent modification takes precedence), user-priority (user-initiated modifications take precedence over automated updates), or conflict-surfacing (the system displays both values and prompts the user to select the authoritative value).

For widgets that may display aggregated data derived from multiple source entities, the state synchronization manager may optionally maintain dependency tracking structures that identify which source entities contribute to each aggregated value. When a source entity is modified (either through conversational input or through direct platform manipulation outside the messaging session), the dependency tracking structure may enable efficient identification and re-computation of affected aggregated values.

The state synchronization may optionally also handle session lifecycle events. When a user's messaging session is suspended (for example, when the user closes the browser tab or mobile application), the system may persist the current widget state to durable storage. When the user resumes the session, the system may retrieve the persisted widget state and reconcile it with any changes that occurred while the session was suspended. The reconciliation process may identify widgets that require refresh based on elapsed time or detected data changes and may queue background refresh operations to restore widget currency.

For example, reference is now made to FIG. 1B, which illustrates an exemplary graphical user interface (GUI) 231 demonstrating the generation of persistent UI widgets based on conversational context analysis within an instant messaging environment. The GUI 231 may optionally comprise a messaging interface enabling real-time communication between a user and an AI agent instance, referred to in this example as “Ziggy,” which may be configured as a specialized stock market analyst agent.

The persistent stock widget 234 may include a company identifier field 233 displaying the ticker symbol and company name, a current price display 235 showing the stock value (e.g., “250.00 USD”), a percentage change indicator 237 (e.g., “+2.50%”) that may optionally be color-coded to indicate positive or negative price movement, and a sparkline chart 236 providing a visual representation of recent price trends.

In this optional embodiment, the GUI 231 may include a header region 232 displaying the AI agent's identity and designation, such as “Ziggy-Stock Market . . . ” indicating the agent's specialized domain expertise. The header region 232 may optionally include navigation elements and subscription options, such as an “Upgrade to Pro” control element that may enable access to enhanced functionality.

The GUI 231 may further comprise a persistent stock widget 234 that is dynamically generated based on conversational context analysis. In the illustrated example, the stock widget 234 displays real-time or near-real-time market data for a stock identified by ticker symbol “MNDY” corresponding to Monday.com. The stock widget 234 may include a company identifier field displaying the ticker symbol and company name, a current price display showing the stock value (e.g., “250.00 USD”), a percentage change indicator (e.g., “+2.50%”) that may optionally be color-coded to indicate positive or negative price movement, and a sparkline chart 236 providing a visual representation of recent price trends.

The natural language processing component may analyze conversational inputs within the messaging session to identify entity references corresponding to publicly traded securities. When the conversational context analysis component detects references to stock market topics, investment strategies, or specific ticker symbols, the UI widget generation component may automatically generate and render the stock widget 234 as a persistent visual element within the GUI 231. The stock widget 234 may remain visually fixed within the messaging interface independent of message scrolling, enabling the user to continuously monitor market data while engaging in conversational interactions with the AI agent.

In some optional embodiments, the GUI 231 may include a disclaimer region 238 positioned between the stock widget 234 and the message display area. The disclaimer region 238 may display informational text advising users that the AI agent provides supportive information but does not replace professional financial advice, that responses may be incomplete, and that users should exercise their own judgment and consult qualified professionals for investment decisions.

The message display area 240 may render conversational exchanges between the user and the AI agent in a sequential message stream format. Each message may optionally include sender identification, message content, and timestamp information. In the illustrated example, the AI agent “Ziggy” introduces itself as a stock market analyst and references the stock widget 234 displayed above, explaining that it shows the performance of the referenced security (MNDY). The AI agent may optionally invite further conversational interaction by querying the user about market topics of interest.

The GUI 231 may further include an input region 242 at a lower portion of the interface, comprising a text input field enabling the user to compose and submit natural language messages. The input region 242 may optionally include attachment controls, emoji selectors, or other input augmentation elements. A submission control may enable transmission of composed messages to the AI agent for processing.

In operation, when a user initiates a messaging session with the stock market analyst AI agent, the conversational context analysis component may continuously monitor the conversation for references to financial instruments, market sectors, investment strategies, or other stock-market-related entities. Upon detection of such references, the system may query external data sources, such as financial market data providers or stock exchange APIs, to retrieve current pricing information. The UI widget generation component may then instantiate a stock widget 234 configured with data bindings linked to the identified security, enabling real-time or periodic updates of the displayed market data.

The state synchronization management component may maintain coordination between the conversational interface and the stock widget 234. When the user discusses a different security in the messaging session, the system may optionally update the existing stock widget 234 to display data for the newly referenced security, or may generate an additional stock widget for the new security while maintaining the existing widget. User interactions with the stock widget 234, such as tapping to expand detailed information or dismissing the widget, may optionally be reflected in the conversational context maintained by the AI agent.

According to one optional embodiment, the stock widget 234 may be configured with automatic refresh policies that periodically update the displayed price data based on configurable intervals (e.g., every 15 seconds, every minute, or on-demand). The refresh policy may optionally be adjusted based on market hours, with more frequent updates during active trading sessions and less frequent or suspended updates during market closures.

According to another optional embodiment, the stock widget 234 may be interactive, enabling the user to tap or click on the widget to access expanded functionality such as historical price charts, fundamental data displays, analyst ratings, or trading controls. Such interactive expansions may appear as overlay panels or may navigate the user to dedicated detail views while preserving the conversational context.

Reference is now also made to FIGS. 1B, 1C and 1D, which illustrate exemplary graphical user interfaces demonstrating the dynamic generation of calendar widgets based on conversational context and the subsequent rendering of interactive meeting detail elements within the messaging interface responsive to user interactions with the generated widgets.

FIG. 1C illustrates a GUI 600 comprising a messaging interface enabling real-time communication between a user and an AI agent instance designated as “Agenda,” which may be configured as a specialized calendar and meeting management agent. The GUI 600 may include a header region 602 displaying the AI agent's identity and functional designation, such as “Agenda-Morning Calendar Brief,” indicating the agent's specialized domain expertise in calendar management and meeting coordination.

The GUI 600 may further comprise a next meeting widget 604 that may be persistently displayed within an upper portion of the interface. The next meeting widget 604 may display information regarding the user's upcoming scheduled event, including a meeting title (e.g., “Taka daily sync”), a countdown indicator (e.g., “in 15h”), a scheduled time (e.g., “10:00 AM”), and a date indicator (e.g., “Nov 3”). The next meeting widget 604 may optionally include an action control 605 enabling direct access to meeting details or joining functionality.

The message display area 606 may render conversational exchanges between the user and the AI agent in a sequential message stream format. In the illustrated example, an AI agent message 607 describes an upcoming meeting with relevant details and offers preparatory assistance. A user message 608 contains a natural language request to display the day's calendar, specifically requesting “show today's calendar on the right.”

Upon receiving and parsing the user message 608, the natural language processing component may extract the user's intent to view calendar information and the spatial preference for widget placement. The conversational context analysis component may identify the temporal reference (“today's calendar”) and the layout directive (“on the right”). Based on this analysis, the UI widget generation component may create and render a calendar widget 612 in a side panel position adjacent to the message display area 606. The calendar widget 612 may comprise a date navigation region 614 including left navigation control and right navigation control (e.g., left and right arrows) enabling the user to navigate between dates, and a current date display 616 showing the selected date (e.g., “Sunday, November”). A date header 617 may display the full date (e.g., “Sunday, Nov. 2, 2025”).

An AI agent response message 610 may confirm the widget generation action, indicating that the calendar has been pinned to the designated location and describing the functionality provided by the calendar widget 612. The AI agent response message 610 may further offer additional assistance options, such as providing meeting summaries or detailed briefs for specific events.

The calendar widget 612 may comprise a date navigation region 614 including navigation controls (e.g., left and right arrows) enabling the user to navigate between dates, and a current date display 616 showing the selected date (e.g., “Sunday, November”). A date header 617 may display the full date (e.g., “Sunday, Nov. 2, 2025”).

The calendar widget 612 may further comprise a time slot grid 618 displaying time intervals (e.g., “10 AM,” “11 AM,” “12 PM,” “1 PM,” “2 PM”) along a vertical axis. Calendar event entries 620 may be positioned within the time slot grid 618 corresponding to their scheduled times. Each calendar event entry 620 may include an event title, a time range indicator 622 (e.g., “10:00 AM-10:30 AM”), and may optionally include an event link 624 providing direct access to meeting resources such as video conferencing URLs.

In the illustrated example, multiple calendar event entries 620 are displayed including “Taka daily sync,” “MCP UI Daily,” time blocks marked as “Busy,” and “Taka-weekly sync.” Each event entry 620 may optionally include an action control 625 enabling access to additional event details or editing functionality.

A user follow-up message 626 may request additional detail regarding a specific calendar event, such as “Provide a visual overview of ‘Taka-weekly sync’ scheduled on Nov. 2, 2025 at 2:00:00 PM.” This request may trigger the generation of an interactive meeting details element within the message stream, as illustrated in FIG. 1D.

Reference is now made to FIG. 1D, which illustrates the GUI 600 following user interaction requesting detailed meeting information. The state synchronization management component may detect the user's request referencing a specific calendar event displayed in the calendar widget 612 and may trigger the UI widget generation component to create an interactive meeting details card 628 within the message display area 606. The GUI 600 may include edit controls (collectively referenced as 650) positioned at various locations.

The meeting details card 628 may be rendered as an inline widget embedded within the conversational message stream. The meeting details card 628 may comprise a meeting invitation header 630 displaying contextual information such as the meeting organizer's invitation text (e.g., “Roni Plawner is inviting you to a scheduled Zoom meeting. Join Zoom Meeting . . . ”).

A date and time display region 632 may present the scheduled meeting date and time range using visual indicators, such as a calendar icon followed by the date (e.g., “Sun, Nov 2”) and a time icon followed by the time range (e.g., “2:00 PM-2:45 PM”). The date and time display region 632 may optionally include editable field indicators enabling the user to modify meeting scheduling directly from within the chat interface.

A location section 634 may include a location label and a location details field 636 displaying the meeting location information. The location details field 636 may include a video conferencing URL (e.g., “monday(dot)zoom(dot)us/j/87127095714”) and/or a physical location identifier (e.g., “TLV Office-18-1804 Meeting Room (22)”). The location details field 636 may include visual indicators suggesting editability, enabling users to modify location information directly within the meeting details card 628.

An organizer section 638 may include an organizer label and organizer details 640 identifying the meeting organizer or organizing entity (e.g., “monday.com PA Meetings”). The organizer section 638 may include a visual icon distinguishing the organizer role.

An attendees section 642 may include an attendees label and a count indicator (e.g., “9 participants”). An attendee list 644 may display attendee identifiers using visual tags or chips, each representing an individual participant (e.g., “Roy,” “Iliya Mezumin,” “Amotz Thaler”). An expandable control 646 (e.g., “+6 more”) may enable the user to view additional attendees not displayed in the initial view. The attendee list 644 may support interactive functionality enabling the user to add, remove, or modify attendees directly from within the meeting details card 628.

The meeting details card 628 may include one or more edit controls positioned at various locations within the card, providing visual affordances indicating that the displayed information fields are editable. When a user interacts with an editable field, the system may present appropriate input controls enabling modification of the meeting details. Modifications made through the meeting details card 628 may be synchronized with underlying calendar data sources through the state synchronization management component.

A user query message 648 (e.g., “where is it?”) may demonstrate continued conversational interaction following the presentation of the meeting details card 628. The AI agent may process this query in context, recognizing that it references the location information within the previously displayed meeting details card 628, and may provide a focused response highlighting the location details.

The calendar widget 612 may remain persistently displayed in the side panel throughout the conversational interaction, enabling the user to reference overall schedule context while examining specific meeting details within the message stream. This hybrid interaction mode enables seamless alternation between structured widget interactions and natural language conversation while maintaining full contextual awareness across both modalities.

According to optional embodiments, the meeting details card 628 may include action buttons enabling the user to perform operations such as joining the meeting, adding the meeting to a personal calendar, sending notifications to attendees, or declining the meeting invitation. Such action buttons may trigger corresponding operations through the state synchronization management component, with results reflected both in the underlying data sources and in the conversational context.

According to other optional embodiments, modifications made to meeting details through the meeting details card 628 may generate synthetic conversational events that appear in the message stream, providing transparency regarding changes made through widget interactions. For example, if a user modifies the meeting time through the date and time display region 632, a system message may appear indicating “Meeting time updated to 3:00 PM-3:45 PM.”

Reference is now made to FIG. 1E, which illustrates an exemplary graphical user interface demonstrating multiple persistent UI widgets operating concurrently within a messaging interface for a calorie tracking and nutrition management application. The GUI 700 may comprise a chat interface panel 702 positioned on a left portion of the interface, displaying a list of available conversations and AI agent instances that the user may interact with.

The GUI 700 may include a primary widget display panel 704 positioned on a right portion of the interface, demonstrating the system's capability to render multiple coordinated persistent UI widgets simultaneously. The widget display panel 704 may comprise a header region 706 displaying the application context (e.g., “Calorie Tracker App”) and may include a close control element enabling the user to dismiss the widget panel.

The widget display panel 704 may include a calendar navigation widget 708 positioned at an upper portion, comprising day-of-week selectors 710 (e.g., “Mon,” “Tue,” “Wed”) and date indicators 712 arranged in a horizontal row. A current date indicator 714 may be visually distinguished through highlighting or distinctive styling (e.g., a circular highlight around “11” representing the current day “Thu”). The calendar navigation widget 708 enables the user to select dates for viewing historical data or planning future nutritional intake.

The widget display panel 704 may further comprise a caloric intake visualization widget 716 displaying quantitative nutritional information in a gauge format. The visualization widget 716 may include a circular gauge representation 718 showing consumed calories against a target threshold, with a numerical indicator 720 (e.g., “1672”) representing remaining caloric budget and range indicators 722 showing minimum and maximum values (e.g., “0” and “100”). The visualization may optionally employ color coding or progressive fill to indicate proximity to dietary targets.

Below the caloric intake widget 716, a time period selector 724 may comprise multiple selectable options (e.g., “Daily,” “Weekly,” “Monthly”) enabling the user to adjust the temporal scope of displayed data. The currently selected option 726 (e.g., “Daily”) may be visually distinguished through distinctive styling, color, or highlighting.

The widget display panel 704 may further comprise a trend analysis widget 728 positioned in a lower portion, displaying temporal patterns in caloric intake over a defined period. The trend analysis widget 728 may include a line chart 730 with multiple overlaid traces 732, 734 representing different data series (e.g., actual intake versus target goals). To ensure accessibility and clarity in both color and grayscale rendering, the traces may employ distinctive line styles including solid lines, dashed lines, and dotted lines, with each trace clearly labeled. The chart may include axis labels 736 indicating numerical ranges and temporal markers 738 (e.g., “Mon,” “Tue,” “Wed”) corresponding to days of the week. A legend region 740 may identify the meaning of different visual elements through both textual labels and pattern indicators, such as “5 days under goal” 742 and “2 days over by more than 200 kcal” 744, ensuring that the chart meaning does not rely exclusively on color differentiation.

In operation, when a user initiates a messaging session with a nutrition management AI agent, the conversational context analysis component may detect recurring references to dietary tracking, caloric intake, or nutritional goals. Based on this detected context, the UI widget generation component may automatically instantiate the widget display panel 704 containing the coordinated set of widgets 708, 716, 728. The widgets may be configured with data bindings linked to the user's nutritional tracking data stored within the platform's database systems.

The state synchronization management component may maintain bidirectional synchronization between the conversational interface and the persistent widgets. When the user interacts with the calendar widget 708 by selecting a different date, the caloric intake widget 716 and trend analysis widget 728 may automatically update to display data corresponding to the selected timeframe. Conversely, when the user provides nutritional information through natural language messages in the chat interface 702 (e.g., “I had a 500 calorie lunch”), the system may update the underlying nutritional database and trigger automatic refresh of the displayed widgets to reflect the new information.

The coordinated widget panel 704 demonstrates the system's capability to generate multiple related widgets that function as an integrated interface element while maintaining persistent visibility alongside the conversational message stream. This multi-widget configuration enables users to benefit from comprehensive data visualization while retaining the flexibility of conversational interaction, exemplifying the hybrid interaction mode disclosed herein.

According to other optional embodiments, for example as depicted in FIGS. 1F and 1G, the disclosed system may be applied across diverse application domains beyond stock market analysis and nutrition tracking. As shown at FIG. 1F, the AI agent system may generate persistent UI widgets for meal planning applications, wherein conversational discussions about dietary preferences may trigger generation of visual meal cards displaying food images, nutritional summaries, and portion recommendations organized by meal type (e.g., breakfast, lunch, dinner, snacks). The system may generate interactive meal planning widgets enabling users to select meal options through direct interaction while simultaneously refining preferences through conversational inputs.

In particular, FIG. 1F is an exemplary graphical user interface illustration 800 showing meal planning widgets for dietary management, according to some embodiments of the present invention. The GUI 800 may comprise a messaging interface 802 and a meal planning panel 804. The meal planning panel 804 may include multiple meal category sections 810, 814, 816, 818 corresponding to breakfast, lunch, dinner, and snacks respectively. Each category section may contain one or more visual meal cards 808 displaying food images 810, nutritional summaries, and portion recommendations. The meal cards 808 may be interactive, enabling users to select meal options through direct interaction while simultaneously refining preferences through conversational inputs in the messaging interface 802.

FIG. 1G is an exemplary graphical user interface illustration 900 showing budget tracking widgets embedded in conversational message streams, according to some embodiments of the present invention. The GUI 900 may comprise a messaging interface 902 with embedded budget widgets 904 displayed inline within the message stream. Each budget widget 904 may include a progress bar 906 showing expenditure against budget limits, a numerical summary displaying spent and remaining amounts, and a category breakdown 910. The budget widgets 904 may include text summaries 912 explaining budget status in natural language, providing both structured visual representations and narrative descriptions of financial information.

In optional financial management contexts, as shown at FIG. 1G, the AI agent system may generate budget tracking widgets that display expenditure progress bars, category-based spending breakdowns, and remaining budget indicators. When users discuss financial transactions or budget allocations through the conversational interface, the budget tracking widgets may automatically update to reflect changed allocations, with the progress visualization dynamically adjusting to show updated percentages and numerical values. The widgets may include text summaries explaining budget status in natural language (e.g., “You've spent 18,900 of 20,000 this month”) alongside visual progress indicators, providing both structured and narrative representations of financial information.

The system may similarly generate widgets for project management (displaying task lists, milestone timelines, and team member assignments), customer relationship management (showing contact histories, interaction timelines, and opportunity pipelines), inventory management (displaying stock levels, reorder triggers, and supplier information), and scheduling applications (rendering calendar views, availability matrices, and meeting coordination interfaces). In each application domain, the conversational context analysis component may detect domain-specific entities and intents, triggering generation of appropriate widget types selected from the widget library or generated through domain-specific widget templates.

Reference is now made to FIG. 2, which is a flowchart illustrating a method corresponding to the system of FIG. 1. The method begins at step 210 with presentation of a messaging GUI enabling message exchange between users and AI agent instances. At step 220, the system parses natural language inputs from user messages in messaging sessions, which may optionally include extraction of semantic entities and identification of recurring interaction patterns.

At step 230, the system may maintain conversational context of messaging sessions based on analysis of parsed natural language inputs. The conversational context may optionally include temporal markers indicating when specific entities were introduced in conversations, frequency tracking of concept references across sessions, and source of truth indicators for each data element within persistent UI widgets.

At step 240, the system creates persistent UI widgets based on conversational context. The creation process may optionally involve selecting widgets from widget libraries based on context scores and programmatically configuring widgets with data bindings linked to extracted semantic entities. At step 250, the system renders the persistent UI widgets as part of the messaging GUI, and may optionally maintain visual positioning independent of message stream scrolling.

At step 260, the system updates persistent UI widgets as users continue interactions with AI agents. Updates comprise adding, removing, or modifying widgets responsive to changes in conversational context. Updates may optionally be triggered by detected shifts in user intent or introduction of new semantic entities identified during parsing.

The method may optionally further include, at step 270, evaluating user feedback on generated widgets. User feedback signals may include explicit feedback actions (such as dismissing a widget, resizing a widget, or rating a widget's usefulness), implicit feedback signals derived from user behavior (such as widget interaction frequency, time spent viewing widget content, and widget-driven actions), and conversational feedback (such as statements praising or criticizing generated widgets). The feedback signals may optionally be aggregated and used to adjust the widget generation parameters for subsequent interactions, implementing a continuous learning loop that improves widget relevance over time.

At optional step 280, the method may include persisting the widget state and configuration to durable storage. The persistence operation may store the widget specification (including template identifier, data bindings, and configuration parameters), the current data values displayed in the widget, the widget position and sizing within the messaging GUI, and metadata including creation timestamp, last modification timestamp, and access scope. The persisted widget state may enable reconstruction of the widget display when the user reconnects after a session interruption or accesses the conversation from a different client device.

In some optional embodiments, the natural language processing component 120 may implement a multi-stage pipeline for analyzing user messages. Reference is now made to an exemplary analysis:

The first stage may perform tokenization using byte-pair encoding (BPE) to convert raw text into token sequences suitable for processing by transformer-based models. The tokenizer may optionally maintain a vocabulary of approximately subword tokens that enables efficient representation of diverse vocabulary including technical terms, proper nouns, and specialized jargon common in workplace communications.

The second stage may optionally apply a named entity recognition (NER) model to identify and classify entities mentioned in user messages. The NER model may be trained to recognize entity types relevant to SaaS platform contexts, including person names, organization names, project names, date and time expressions, numerical quantities, status indicators, and references to platform-specific objects such as boards, items, and columns. The NER model may optionally employ a BiLSTM-CRF architecture or a transformer-based sequence labeling model that assigns entity type labels to each token in the input sequence.

The third stage may optionally perform intent classification using a multi-label classifier that identifies user intents from a predefined taxonomy. Intent categories may include information queries (requests for data retrieval), action requests (commands to perform operations), status updates (statements providing new information), planning expressions (statements about future activities), and coordination requests (attempts to synchronize with other users). The intent classifier may output probability scores for each intent category, enabling the system to detect multiple concurrent intents within a single message.

The fourth stage may optionally perform semantic analysis to identify relationships between extracted entities and to resolve references to entities mentioned in previous messages within the conversational context. The semantic analysis component may maintain a coreference resolution model that links pronouns and definite noun phrases to their antecedents. For example, when a user states “update its status to complete,” the semantic analysis component may identify that “its” refers to a specific item mentioned earlier in the conversation.

The fifth stage may optionally calculate context scores that quantify the probability that structured visualization would enhance user task completion. The context score calculation may incorporate multiple signals including the frequency of entity references, the presence of quantitative data, the detection of comparison or trend analysis intents, the identification of tracking or monitoring language, and historical patterns of user interaction. The context score may be computed as a weighted combination of these signals, with weights optionally optimized through supervised learning on labeled examples of conversations where widget generation proved beneficial.

In some optional embodiments, the conversational context analysis component 130 may maintain a structured representation of the ongoing conversation that persists across multiple messaging sessions. The conversational context may comprise several interrelated data structures stored in both volatile memory for rapid access and persistent storage for durability across system restarts.

An optional entity registry may maintain records of all entities mentioned during the conversation, including entity identifiers, entity types, first mention timestamps, most recent mention timestamps, mention frequencies, and extracted attribute values. Each entity record may be linked to the specific messages in which the entity was mentioned, enabling retrieval of the original conversational context surrounding entity introduction. The entity registry may optionally employ a hash-based indexing structure that enables O(1) lookup of entity records by identifier and supports efficient range queries on timestamp fields.

An optional intent history may maintain a time-ordered sequence of detected user intents, enabling the system to identify patterns in user behavior and anticipate future needs. The intent history may be analyzed using sliding window techniques to detect recurring intent patterns. For example, if a user repeatedly requests status updates for the same set of items across multiple sessions, the system may detect this pattern and may proactively generate a status dashboard widget.

An optional context embedding vector may capture a dense numerical representation of the current conversational state. The context embedding may be computed by applying a transformer encoder to the concatenation of recent messages and may be updated incrementally as new messages are received. The context embedding vector may be used for rapid similarity comparisons when selecting relevant information from the widget library or when matching the current context to historical interaction patterns.

An optional relationship graph may maintain a directed graph structure representing detected relationships between entities. Nodes in the graph may correspond to entities in the entity registry, and edges may represent relationships such as ownership (user owns item), membership (item belongs to board), dependency (task depends on task), assignment (person is assigned to task), and temporal ordering (event occurs before event). The relationship graph may be updated as new relationship mentions are detected in user messages and may be queried when generating widgets that visualize inter-entity relationships.

An optional source of truth registry may track the authoritative source for each data element within the conversational context. For each entity attribute, the registry may record whether the value originated from explicit user statements, was inferred by the AI agent, was retrieved from platform data sources, or was synthesized from multiple sources. This provenance tracking may enable the system to prioritize authoritative sources when conflicts arise and to indicate confidence levels in generated widgets.

To illustrate the complete operation of the disclosed system, consider the following exemplary scenario:

A product manager initiates a messaging session with the AI agent and sends the message: “Let's review the Q4 marketing budget status for Project Phoenix.” (Step 210—message exchange through messaging GUI)

The natural language processing component 120 parses this input and extracts semantic entities including the project identifier “Project Phoenix,” the temporal reference “Q4,” and the domain indicator “marketing budget.” The intent classifier identifies the user intent as “status_inquiry” with a confidence score of 0.92. (Step 220—parsing natural language inputs)

The conversational context analysis component 130 updates the conversational context to include these extracted entities and intents. The component retrieves historical interaction patterns for this user and identifies that the user has previously benefited from budget tracking widgets in similar contexts. The entity registry records that “Project Phoenix” has been mentioned 3 times in the last 5 messages, yielding an Entity_Frequency of 0.60. The presence of “budget” indicates Quantitative_Data_Presence=1.0. The “review” and “status” language triggers Tracking_Language_Detection=1.0. The Historical_Benefit_Pattern for budget widgets with this user is 0.85. Using the exemplary formula disclosed above, the system computes:

Context_Score=(0.60×0.25)+(1.0×0.20)+(0.92×0.25)+(1.0×0.15)+(0.85×0.15)=0.15+0.20+0.23+0.15+0.13=0.86

Since this context score of 0.86 exceeds the configured threshold of 0.70, the system proceeds with widget generation. (Step 230—maintaining conversational context)

The UI widget generation component 140 evaluates templates in the widget library 150 and identifies that a “budget_tracking_dashboard” template has a high match score (0.83) with the current context signature. The component instantiates this template and configures it with data bindings linking to Project Phoenix's Q4 marketing budget data retrieved from the platform's database. The configured widget displays current expenditure (e.g., $45,000 spent of $60,000 allocated), a visual progress bar showing 75% utilization, and a category breakdown chart. (Step 240—creating persistent UI widgets)

The messaging GUI component 110 renders the budget tracking widget in a side panel position adjacent to the message stream, with the widget pinned such that it remains visible independent of message scrolling. The AI agent responds conversationally: “I've created a Q4 marketing budget dashboard for Project Phoenix. You've used 75% of the allocated $60,000, with $15,000 remaining. The largest expenditure categories are digital advertising ($22,000) and content creation ($15,000).” (Step 250—rendering persistent UI widgets)

The product manager continues the conversation, writing: “Let's reduce the digital advertising allocation by $5,000 and increase content creation by $3,000.” The natural language processing component parses this directive and the state synchronization management component 160 detects that the user's request references the budget categories displayed in the persistent widget. The component updates the underlying budget data to reflect the reallocation: digital advertising reduced from $22,000 to $17,000, content creation increased from $15,000 to $18,000. The widget automatically refreshes to display the updated allocation, and the AI agent confirms: “I've updated the allocations. Digital advertising is now $17,000 and content creation is $18,000. The widget has been updated to reflect these changes.” (Step 260—updating persistent UI widgets)

When the product manager closes the browser and later resumes the session from a different device, the system retrieves the persisted widget state from durable storage and reconstructs the budget tracking widget with the current data values, maintaining continuity across the session boundary. (Step 280—persisting widget state and configuration).

This example illustrates the complete flow from conversational input through entity extraction, context score calculation, widget selection and configuration, rendering, interactive update, and cross-session persistence.

According to one optional embodiment recited with reference to the above system or method, the system may enable hybrid interaction wherein users can seamlessly alternate between issuing natural language commands through chat interfaces and performing structured operations through persistent UI widgets, with state synchronization maintained between both interaction modalities. These embodiments may provide technical benefits including reduced context switching overhead, improved workflow continuity, and enhanced user productivity through seamless integration of conversational and structured interaction modes.

According to one or more other optional embodiments recited with reference to the above system or method, persistent UI widgets may remain visually fixed within messaging GUIs independent of scrolling message streams and may persist across multiple user sessions. These embodiments may provide technical benefits including consistent visual reference points for users, reduced cognitive load from interface reconstruction, and maintained context across session boundaries.

According to one or more other optional embodiments recited with reference to the above system or method, the system may parse natural language inputs by extracting semantic entities from natural language inputs, identifying recurring interaction patterns, and assigning context scores indicating probability that structured visualization would enhance user task completion. These embodiments may provide intelligent interface adaptation, proactive UI generation, and optimized user experience through predictive interface elements.

According to one or more other optional embodiments recited with reference to the above system or method, the system may update persistent UI widgets by selecting widgets from widget libraries based on context scores exceeding predetermined thresholds. These embodiments may provide automated widget selection, reduced manual configuration requirements, and dynamic interface adaptation based on usage patterns.

The UI widget generation component 140 may implement a widget selection algorithm comprising the following steps:
Step 1: Context Signature Extraction Extract from the current conversational context: (a) primary entity types (e.g., “project,” “task,” “financial_account”), (b) detected intent categories (e.g., “status_inquiry,” “trend_analysis,” “planning”), and (c) data characteristics (e.g., presence of temporal data, quantitative metrics, or hierarchical relationships).
Step 2: Template Matching Computation For each widget template in the widget library 150, compute a match score according to: Match_Score=(Entity_Type_Overlap×0.4)+(Intent_Alignment×0.4)+(Data_Characteristic_Match×0.2)

### Where:

Entity_Type_Overlap=(Number of matching entity types)/(Total entity types in context signature)
Intent_Alignment=Maximum confidence score among matching intent categories
Data_Characteristic_Match=(Number of matching data characteristics)/(Total data characteristics in template)
Step 3: Candidate Selection Select widget templates with Match_Score exceeding a configurable threshold (e.g., 0.60 as a non-limiting example).
Step 4: Final Selection If multiple templates exceed the threshold:
If fewer than 3 candidates: present all candidates to user for selection
If 3 or more candidates: select the template with highest Match_Score
If Match_Scores are within 0.05 of each other: apply a learned preference model based on user's historical widget interaction patterns
   Context contains:
Entity types: [“project”, “task”, “user”]
Detected intents: [“status_inquiry” (confidence 0.9), “planning” (confidence 0.6)]
Data characteristics: [“temporal_data”, “quantitative_metrics”, “assignee_relationships”]

### Template A: Project Status Dashboard

Context signature entity types: [“project”, “task”]
Context signature intents: [“status_inquiry”, “progress_tracking”]
Context signature data characteristics: [“temporal_data”, “quantitative_metrics”]
   Match_Score_A calculation:
Entity_Type_Overlap=2/3=0.667 (2 matching: “project”, “task”)
Intent_Alignment=0.9 (highest confidence for matching intent “status_inquiry”)
Data_Characteristic_Match=2/3=0.667 (2 matching: “temporal_data”, “quantitative_metrics”)
Match_Score_A=(0.667×0.4)+(0.9×0.4)+(0.667×0.2)=0.267+0.360+0.133=0.760

### Template B: Task Assignment Matrix

Context signature entity types: [“task”, “user”]
Context signature intents: [“assignment_query”, “resource_planning”]
Context signature data characteristics: [“assignee_relationships”, “hierarchical_data”]
   Match_Score_B calculation:
Entity_Type_Overlap=2/3=0.667 (2 matching: “task”, “user”)
Intent_Alignment=0.6 (highest confidence for matching intent “planning”)
Data_Characteristic_Match=1/3=0.333 (1 matching: “assignee_relationships”)
Match_Score_B=(0.667×0.4)+(0.6×0.4)+(0.333×0.2)=0.267+0.240+0.067=0.574

With a threshold of 0.60, Template A (Match_Score 0.760) exceeds the threshold and is selected. Template B (Match_Score 0.574) does not meet the threshold. The system generates a Project Status Dashboard widget configured with data bindings to the referenced project and task entities.

According to one or more other optional embodiments recited with reference to the above system or method, each persistent UI widget may be programmatically configured with data bindings linked to extracted semantic entities. These embodiments may provide automatic data population, real-time widget updates based on conversational content, and reduced manual data entry requirements.

According to one or more other optional embodiments recited with reference to the above system or method, updates to persistent UI widgets may be triggered by detected shifts in user intent or introduction of new semantic entities identified during parsing. These embodiments may provide responsive interface adaptation, contextually relevant widget updates, and improved user experience through predictive interface changes.

According to one or more other optional embodiments recited with reference to the above system or method, persistent UI widgets may be accessible to multiple AI agents for interaction and adaptation. These embodiments may provide enhanced collaborative capabilities between AI agents, shared context maintenance across different AI instances, and improved system scalability through distributed AI agent interactions.

According to one or more other optional embodiments recited with reference to the above system or method, the system may implement conflict resolution mechanisms when multiple AI agents attempt to modify the same persistent UI widget, may establish modification priority protocols, and may maintain data consistency across concurrent widget interactions. These embodiments may provide prevention of data corruption, maintained system integrity under concurrent access, and reliable multi-agent collaboration.

According to one or more other optional embodiments recited with reference to the above system or method, each persistent UI widget may be associated with defined access scopes selected from platform-level access enabling visibility to all users, team-level access restricting visibility to designated team members, and user-level access limiting visibility to individual user profiles. These embodiments may provide appropriate data security, controlled information sharing, and compliance with organizational access policies.

According to one or more other optional embodiments recited with reference to the above system or method, the system may maintain widget data provenance by storing source attribution data indicating whether widget data originates from user-specific sources, AI agent-generated sources, or platform-wide sources, and preserving linkage information connecting widget modifications to specific conversational messages that triggered the modifications. These embodiments may provide audit trail maintenance, debugging capabilities, and enhanced system transparency.

In one optional exemplary implementation within a SaaS project management platform, the AI agent system may integrate with the platform's task and item management capabilities to generate task context widgets. The platform may maintain a searchable index of all items (tasks, projects, issues, and other work items) within each account. The index may include dense vector embeddings computed for each item based on the item's name, description, column values, and associated comments. These embeddings may enable semantic similarity search that identifies items related to a given query or context.

When a user initiates a messaging session and discusses a specific task or project, the natural language processing component may extract entity references corresponding to the discussed items. The system may then query the semantic search index to identify related items that may provide relevant context. Related items may optionally include items with similar descriptions (indicating potential duplicates or related work), items assigned to the same team members, items within the same project hierarchy, items with temporal dependencies, and items that were previously discussed in similar conversational contexts.

The AI agent may optionally evaluate the retrieved related items to determine which provide meaningful context for the current conversation. This evaluation may employ a learned classifier that predicts context relevance based on features including semantic similarity scores, recency of related item updates, organizational relationship strength, and historical patterns of co-reference in conversations. Items that pass the relevance threshold may be incorporated into a task context widget.

The optional task context widget may display multiple categories of contextual information. The related items section may list items with high semantic similarity, with each item showing its name, status, assignee, and a brief explanation of why the AI identified it as related. The recent activity section may display recent code commits, document edits, and status changes associated with the discussed items or related items. The people section may identify team members who are involved with related items and may have relevant knowledge or context. The risks section may highlight potential issues detected by the AI, such as duplicate items representing redundant work, conflicting changes made to related items, or approaching deadlines that may create timeline pressure.

The task context widget may optionally be generated proactively when the AI detects that the user is discussing a task or project that would benefit from contextual enrichment. The widget may appear as a collapsible panel at a designated position within the messaging GUI, enabling the user to reference contextual information while continuing the conversation. The user may expand individual sections of the widget to view additional detail or collapse sections to minimize visual overhead.

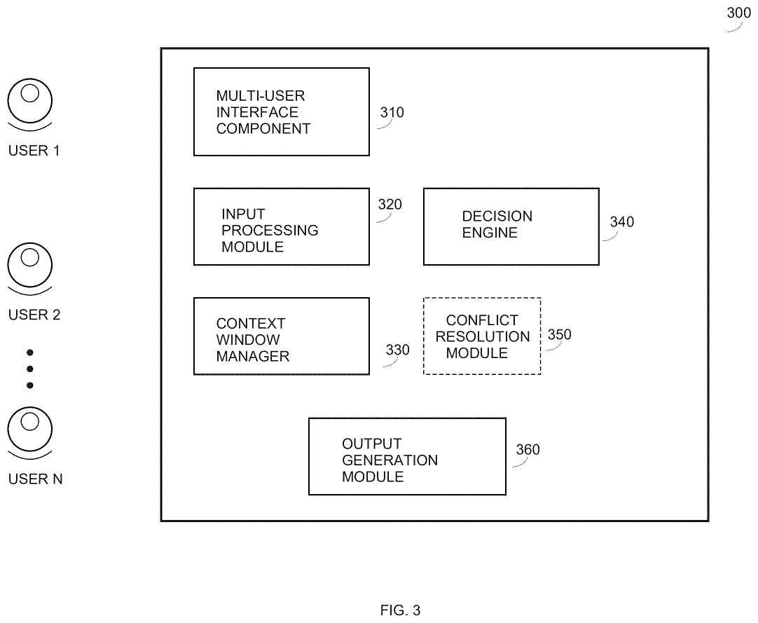

Reference is now made to FIG. 3, which is a schematic illustration of a system for processing multi-user inputs to an AI agent. The system 300 comprises a multi-user interface component 310, an input processing module 320, a context window manager 330, a decision engine 340, and an output generation module 360. In some optional embodiments, the system may further comprise a conflict resolution module 350.

The multi-user interface component 310 receives input messages from multiple distinct users within defined time windows. Each input message is timestamped and associated with unique user identifiers. The context window manager 330 establishes context windows that expand as additional participants add context, managing the temporal boundaries for considering related inputs.

In some embodiments, components 310, 320, 330, 340, 350, and 360 may be implemented as server-side processing modules 301 communicating with client-side interface components through network connections. The multi-user interface component 310 may include both server-side message reception logic 310a and client-side rendering components 310b, with the boundary indicated by dashed line 305 in FIG. 3.

In optional embodiments, the input processing module 320 may extract factual assertions and sentiment indicators from each input message and may construct conflict detection matrices identifying contradictory directives between users. The module may assign priority weights to each input message based on user roles, message timestamps, and detected confidence levels.

The decision engine 340 may execute decision phases comprising identification of distinct instruction sets within context windows and determination of which instruction sets align with each other and which conflict with each other. The engine may optionally evaluate whether conflicting instruction sets are interdependent such that execution is deferred until resolution.

In optional embodiments, the conflict resolution module 350 may process conflicting directives through computational fusion according to priority weights and conflict detection matrices. The module may employ semantic analysis to identify conflicts beyond direct contradictions, including incompatible resource allocations, mutually exclusive task sequences, and conflicting priority assignments.

The conflict resolution module 350 may optionally implement multiple resolution strategies that may be selected based on conflict characteristics and organizational policies. The voting-based resolution strategy may count the number of users supporting each conflicting directive and select the directive with majority support. The authority-based resolution strategy may defer to the user with the highest organizational authority relevant to the decision type (for example, deferring to project owners for project scope decisions). The recency-based resolution strategy may favor more recent directives on the assumption that later messages may reflect updated information or revised preferences. The synthesis resolution strategy may attempt to identify a compromise position that partially satisfies all conflicting directives.

In some embodiments, the system may maintain an interaction history that tracks which users contributed to resolved conflicts, stores resolution patterns for similar future conflicts, and adaptively adjusts the decision phase based on historical resolution outcomes. The interaction history may record metadata for each resolved conflict including the users who participated in the conflict discussion, the type of conflict (resource allocation, priority assignment, timeline decision, etc.), the resolution method employed (voting, authority-based, recency-based, synthesis), the time required to reach resolution, and any explicit feedback from users about the resolution process.

The system may analyze the interaction history to identify resolution patterns, such as observing that for budget allocation conflicts involving a particular team, the finance manager's directive typically prevails, or that timeline conflicts in a specific project context are typically resolved through recency-based prioritization. These learned patterns may be encoded as resolution preference rules that inform future decision phase operations.

The decision engine 340 may adaptively adjust its conflict resolution logic based on historical outcomes by increasing the priority weight assigned to resolution methods that have historically led to successful outcomes (measured by user acceptance, lack of subsequent reversal, and positive explicit feedback) and decreasing the priority weight assigned to methods that have led to unsatisfactory outcomes. This adaptive learning enables the system to progressively improve its ability to resolve multi-user conflicts in ways that align with each team's specific decision-making preferences and organizational culture.

The system may handle asynchronous multi-user inputs by implementing differentiated processing strategies for synchronous and asynchronous input patterns. The input processing module 320 may maintain separate processing queues for synchronous input messages (characterized by rapid message exchange with inter-message intervals typically less than 2 minutes) and asynchronous input messages (characterized by longer inter-message intervals, often spanning hours or days in threaded discussion contexts).

For synchronous input queues, the context window manager 330 may apply shorter context window durations (e.g., 30 seconds to 5 minutes) to enable responsive processing of rapidly evolving discussions. The decision engine 340 may operate in low-latency mode, generating unified outputs quickly to maintain conversational flow. For asynchronous input queues, the context window manager may apply longer context window durations (e.g., 4 hours to 48 hours) to ensure that all relevant contributions from participants across different time zones or work schedules are captured before generating unified outputs.

The system may generate interim unified outputs for time-sensitive directives identified within synchronous discussions while continuing to process asynchronous inputs for non-urgent topics. For example, if a synchronous discussion produces an urgent directive (“We need to update the client presentation immediately”), the system may execute this directive and generate an interim unified output confirming the action, while simultaneously maintaining an open context window for an ongoing asynchronous discussion about long-term strategy that does not require immediate resolution. This differentiated processing enables the AI agent to balance responsiveness for urgent matters with thoroughness for deliberative discussions.

In optional embodiments, the output generation module 360 may format unified outputs using templates that maintain conversational naturalness while ensuring clarity. Templates may include structures for presenting resolutions (“Based on the team's input, we'll proceed with X because Y”), requesting clarification (“I noticed different perspectives on X—could you clarify whether the team wants A or B?”), acknowledging aligned inputs (“Great, the team is aligned on X—I'll proceed accordingly”), and reporting completed actions (“Done—I've updated the project plan to reflect the team's decisions”).

The output generation module 360 may generate unified outputs by computationally fusing distinct instruction sets that align with each other and instruction sets that conflict with each other. Conflicting directives trigger generation of clarifying queries directed to multiple users, while non-conflicting directives are merged into executable actions or consolidated responses.

The multi-user input processing system addresses a fundamental challenge in collaborative work environments: enabling AI agents to effectively participate in team discussions where multiple people contribute simultaneously or near-simultaneously with potentially conflicting or complementary inputs. Rather than requiring the AI agent to respond individually to each user's message in isolation, the system intelligently synthesizes collective intent from multiple concurrent inputs and generates unified responses that address the group as a whole.

The system operates through a coordinated pipeline: (1) multiple users interact with a shared AI agent within collaborative contexts such as team chat channels or project discussion threads; (2) the system identifies temporal clusters of messages that form coherent context windows based on timing, semantic coherence, and topic continuity; (3) within each context window, the system analyzes the collective input to identify distinct instruction sets or directives from different users; (4) the system determines alignment and conflict relationships between these instruction sets through semantic analysis and pairwise comparison; (5) for aligned instruction sets, the system computationally fuses them into unified actions or consolidated responses; (6) for conflicting instruction sets, the system generates clarifying queries that efficiently surface the conflict to enable team resolution; and (7) the system produces a single unified output that appropriately synthesizes the collective team input.

This multi-user processing capability transforms the AI agent from a one-to-one conversational partner into a one-to-many collaborative facilitator that can help teams reach consensus, identify conflicts early, and maintain coherent forward progress in collaborative work. The system is particularly valuable in fast-paced team environments where waiting for sequential individual responses would introduce unacceptable latency and where intelligent synthesis of diverse perspectives adds substantial value.

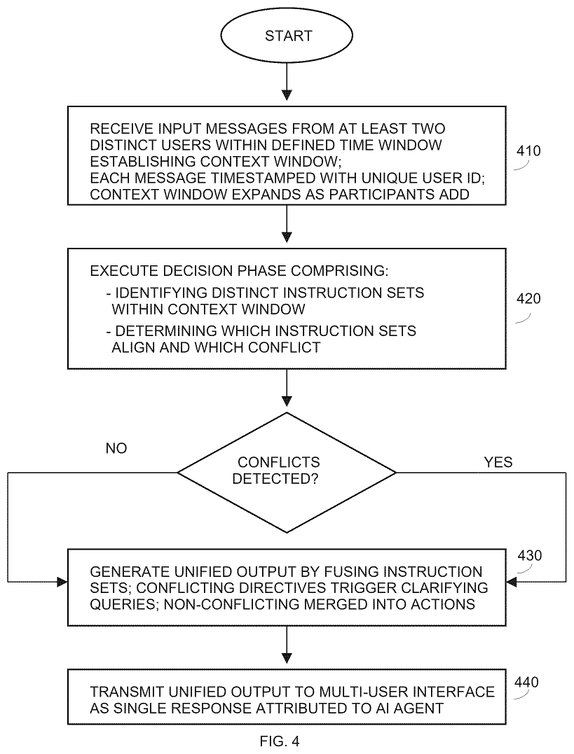

The following detailed description explains the system architecture (FIG. 3), illustrates the operational flow (FIG. 4), and provides specific examples of conflict detection, priority weighting, and unified output generation mechanisms. As with the system description, specific implementation details are provided as non-limiting examples.

The multi-user input processing system described with reference to FIGS. 3 and 4 implements a pipeline for receiving, analyzing, and synthesizing inputs from multiple concurrent users. This capability may be particularly valuable in SaaS collaborative platforms where team members may frequently interact with shared AI agents during group discussions, planning sessions, and decision-making processes.

For example, the context window manager 330 may determine context window boundaries according to the following explicit criteria:

Inclusion Criteria (messages are included in the context window if):
The message timestamp falls within the temporal window bounds (start time to current time)
The message exhibits semantic coherence with the window topic (measured by cosine similarity of message embedding to window centroid embedding exceeding 0.65 as a non-limiting example)
The message is authored by a user who has permission to interact with the AI agent in the current conversation thread
The message contains at least one explicit directive, factual assertion, or question directed to the AI agent
   Exclusion Criteria (messages are excluded from the context window if):
The message is identified as off-topic based on semantic similarity below threshold (e.g., cosine similarity<0.30)
The message timestamp precedes the window start time by more than a configured maximum history period (e.g., 24 hours for asynchronous contexts)
The message contains only social pleasantries or acknowledgments without substantive content (e.g., “thanks,” “ok,” “got it”) as determined by intent classification
The message is designated as private or confidential and not authorized for AI agent processing based on message metadata

### Context Window Temporal Boundaries:

Start Time: Determined by the timestamp of the first message that either (a) explicitly mentions the AI agent by name or tag, or (b) follows a detected topic shift in an ongoing conversation
End Time (Window Closure Triggers):
   Silence Period: No new messages received for a duration exceeding a silence threshold (e.g., 120 seconds for synchronous real-time conversations, 4 hours for asynchronous threaded discussions)
   Topic Shift Detection: A new message is received with semantic similarity to the current window centroid below a topic coherence threshold (e.g., 0.40)
   Explicit Closure: A user explicitly signals conversation completion (e.g., “that's all for now,” “end discussion”)
   Maximum Duration: The context window has remained open for a maximum duration (e.g., 15 minutes for synchronous contexts, 48 hours for asynchronous contexts) regardless of continued activity

### Worked Example of Context Window Management:

Initial State: No active context window
T0 (00:00): User A: “@AIAgent, let's discuss the Q4 budget”→Context window opens (start time=T0), includes Message 1
T1 (00:23): User B: “We need to allocate more for marketing”→Semantic similarity to window=0.78 (>0.65), message included in window
T2 (00:45): User C: “Agreed on marketing, but keep R&D flat”→Semantic similarity to window=0.82 (>0.65), message included in window
T3(01:30): User A: “Anyone want coffee?”→Semantic similarity to window=0.15 (<0.30), message excluded as off-topic
T4 (02:10): User B: “What about the engineering hiring budget?”→Semantic similarity to window=0.71 (>0.65), message included in window→Elapsed time since last relevant message (T2 to T4)=85 seconds (<120-second silence threshold)
T5(04:25): [No messages for 135 seconds]→Silence threshold exceeded (135 s>120 s)→Context window closes, decision phase executes on Messages 1, 2, 3, 4→Unified output generated addressing budget allocation for marketing, R&D, and engineering hiring

The multi-user interface component 310 receives input messages through multiple channels that may optionally include real-time chat messages transmitted over WebSocket connections, asynchronous messages submitted through the platform's messaging API, @mentions that explicitly summon the AI agent's attention, and reaction events that indicate user agreement or disagreement with prior messages. Each received message may be enriched with metadata including the message timestamp (with millisecond precision synchronized to a global time source), the unique user identifier of the message author, the user's organizational role and permissions, the thread or channel in which the message was posted, and any explicit reply relationships to prior messages.

In optional embodiments, the context window manager 330 may implement dynamic context window sizing based on conversational characteristics. The initial context window size may be set based on the detected conversation type (synchronous real-time discussion versus asynchronous threaded conversation). During synchronous discussions characterized by rapid message exchange, the context window may be sized to include all messages within a short time interval (for example, 30 seconds to 2 minutes) to capture the full context of a single decision point. During asynchronous discussions, the context window may span longer time periods but may include only messages that exhibit semantic coherence with the current topic. The context window boundary may optionally be adjusted dynamically based on multiple conversational characteristics. The context window manager 330 may evaluate detected conversation velocity (the rate of message exchange among participants), topic complexity (the semantic richness and technical depth of the discussed subject matter), and historical patterns of user interaction timing (learned patterns of how quickly this particular group of users typically exchanges messages in collaborative discussions).

When conversation velocity is high (e.g., messages arriving at intervals of less than 10 seconds), indicating rapid synchronous discussion, the context window duration may be shortened (e.g., to 30-90 seconds) to enable the AI agent to respond promptly to fast-moving conversations. Conversely, when conversation velocity is low (e.g., messages arriving at intervals exceeding 5 minutes), indicating asynchronous discussion, the context window duration may be extended (e.g., to 30 minutes or several hours) to capture all relevant contributions before generating unified outputs.

Topic complexity may be assessed through metrics including average sentence length, vocabulary sophistication scores, presence of technical terminology, and reference density (frequency of citations to external entities or documents). When topic complexity is high, the context window duration may be extended to allow participants more time to articulate nuanced positions and to enable the AI agent to accumulate sufficient context for generating informed responses.

Historical patterns of user interaction timing may be learned from prior collaborative sessions involving the same or similar participant groups. The system may maintain statistical models of typical response latencies for each user and for each team. When a participant who historically responds within 2 minutes has not yet contributed after 5 minutes in a current discussion, the context window manager may extend the window duration to await the expected contribution. These dynamic adjustments enable the context window to adapt intelligently to the specific characteristics of each collaborative conversation.

In optional embodiments, the input processing module 320 may perform parallel analysis of all messages within the current context window. For each message, the module may extract factual assertions (statements that can be evaluated as true or false), directive statements (requests or commands that imply desired actions), preference expressions (statements indicating user preferences or priorities), and sentiment indicators (emotional valence and intensity). The extraction process may employ transformer-based sequence labeling models fine-tuned on labeled examples of collaborative workplace conversations.

An optional conflict detection matrix may be constructed by comparing extracted content across all message pairs within the context window. For each message pair, the system may evaluate multiple conflict dimensions. Direct contradiction detection may identify cases where one message asserts a fact that is explicitly negated by another message. Preference conflicts may identify cases where users express incompatible preferences (for example, one user requests a deadline extension while another requests expedited delivery). Resource conflicts may identify cases where user requests would require the same limited resource (for example, multiple users requesting priority allocation of a shared team member's time). Sequence conflicts may identify cases where requested action orderings are mutually incompatible.

Optional priority weight assignment may incorporate multiple signals to determine the relative influence of each input message in the unified output generation. User role-based priority may assign higher weights to messages from users with relevant authority or expertise (for example, project owners for project-related decisions, technical leads for technical decisions). Timestamp-based priority may assign higher weights to more recent messages on the assumption that they reflect updated information or revised preferences. Confidence-based priority may assign higher weights to messages that express directives with high certainty language and lower weights to tentative or hedged suggestions. Explicit priority indicators in the message content (such as “this is critical” or “if possible”) may also influence weight assignment. In some embodiments, when the decision phase identifies aligned, non-conflicting instruction sets that collectively specify creation or modification of a work product, the output generation module 360 may execute the fused directives to generate or modify the work product automatically. The work product may include documents, presentations, reports, data visualizations, project plans, or any other tangible output artifact relevant to the collaborative work context. For example, when multiple users provide complementary input about a document's content structure (e.g., User A: “Include a financial summary section,” User B: “Add charts showing quarterly trends,” User C: “Incorporate the Q3 results”), the system may synthesize these aligned directives and generate a unified document that incorporates all requested elements. The generated work product may be presented to all participating users through the multi-user interface, with attribution indicating that the artifact was generated based on collective team input. This capability enables the AI agent to function as an active collaborator that not only facilitates discussion but also produces tangible deliverables based on team consensus.

The input processing module 320 may assign priority weights to each input message based on multiple factors. In one exemplary embodiment, priority weights may be calculated according to the following formula: Priority_Weight=(Role_Factor×R_Weight)+(Recency_Factor×T_Weight)+(Confidence_Factor×C_Weight)

### Where:

Role_Factor is a numerical multiplier based on the user's organizational role relevant to the decision context (e.g., 2.0 for project owners, 1.5 for technical leads, 1.0 for contributors, 0.8 for observers)
Recency_Factor is computed as: 1.0−(Time_Elapsed/Max_Window_Duration), providing higher weight to more recent messages
Confidence_Factor is extracted from the message content based on linguistic certainty indicators (e.g., 1.0 for “we must,” 0.8 for “we should,” 0.5 for “we could consider,” 0.3 for “maybe”)
R_Weight, T_Weight, and C_Weight are configurable weight coefficients (exemplary values: 0.50, 0.30, 0.20 respectively)

Consider a context window containing three messages from distinct users regarding whether to extend a project deadline: Message 1 (User A—Project Owner, timestamp T0): “We must extend the deadline to ensure quality.” Role_Factor=2.0 (project owner) Recency_Factor=1.0−(0/120)=1.0 (most recent message, 0 seconds elapsed in 120-second window) Confidence_Factor =1.0 (“must” indicates high certainty) Priority_Weight_A=(2.0×0.50)+(1.0×0.30)+(1.0×0.20)=1.0+0.30+0.20=1.50.

Message 2 (User B—Technical Lead, timestamp T0—45 s): “We could consider a one-week extension if needed.” Role_Factor=1.5 (technical lead) Recency_Factor=1.0−(45/120)=0.625 Confidence_Factor=0.5 (“could consider” indicates moderate certainty) Priority_Weight_B=(1.5×0.50)+(0.625×0.30)+(0.5×0.20)=0.75+0.19+0.10=1.04.

Message 3 (User C—Contributor, timestamp T0—80 s): “I think we should stick to the original deadline.” Role_Factor=1.0 (contributor) Recency_Factor=1.0−(80/120)=0.333 Confidence_Factor=0.8 (“should” indicates good certainty) Priority_Weight_C=(1.0×0.50)+(0.333×0.30)+(0.8×0.20)=0.50+0.10+0.16=0.76.

The decision engine 340 identifies that Message 1 and Message 3 express conflicting directives (extend vs. maintain deadline). Based on the priority weights, Message 1 from the Project Owner (weight 1.50) takes precedence over Message 3 from the Contributor (weight 0.76). The unified output may therefore state: “Based on the team's input, we'll proceed with extending the deadline to ensure quality, as requested by [User A]. The extension will be one week, incorporating [User B]'s suggestion.

In some embodiments, the AI agent functions as a central hub for collaborative work, maintaining comprehensive awareness of multiple information streams throughout the collaborative session. The system may maintain awareness of individual user contributions and perspectives by associating each input message with the contributing user's identifier, role, historical expertise areas, and typical communication patterns. This enables the AI agent to understand not only what was said but also who said it and what perspective or expertise that user brings to the discussion.

The system may track evolving group consensus by identifying areas where multiple users express agreement (detected through explicit agreement statements, supportive sentiment, and aligned directives) and distinguishing these consensus areas from topics still under active discussion or debate. The decision engine 340 may maintain a consensus state model that quantifies the degree of alignment on each discussed topic, enabling the AI agent to recognize when sufficient consensus has emerged to warrant action or when additional discussion is needed.

The system may also maintain a list of unresolved discussion points requiring group attention, explicitly tracking topics where conflicting views have been expressed, questions that have been posed but not answered, or action items that have been suggested but not confirmed. The AI agent may periodically surface these unresolved points to the group through proactive summary messages (e.g., “We've aligned on the budget allocation, but the timeline question from Sarah is still open—does the team want to address that now?”), ensuring that important discussion points are not lost in high-velocity conversations.

This central hub functionality enables the AI agent to serve not merely as a passive responder but as an active facilitator that helps teams maintain productive forward progress while ensuring all perspectives are considered.

To support its role as a central hub, the system may maintain a conversation state model that tracks the collective discussion trajectory over time. The conversation state model may represent the discussion as a directed graph where nodes represent distinct topics or decision points and edges represent transitions between topics as the conversation evolves. Each node may be annotated with metadata including when the topic was introduced, which users have contributed to the topic, the current consensus level on the topic, and whether the topic has been resolved or remains open.

The system may identify convergence points where user inputs align by detecting clusters of messages that express compatible intents, provide complementary information, or explicitly acknowledge agreement. Convergence points may be marked in the conversation state model as resolved topics with associated consensus decisions. For example, when analyzing messages “Let's go with the Q1 launch date” (User A), “Q1 works for me” (User B), and “Agreed on Q1” (User C), the system identifies a convergence point on the launch date decision.

Conversely, the system may highlight divergence points requiring group resolution by identifying clusters of messages that express incompatible preferences, contradictory assertions, or explicit disagreement. Divergence points may be flagged in the conversation state model as requiring further discussion or explicit resolution. The AI agent may proactively surface these divergence points through clarifying questions or by explicitly summarizing the conflicting positions to facilitate resolution.

The conversation state model enables the AI agent to maintain coherent context across extended multi-user discussions, ensuring that the collective discussion trajectory remains visible to all participants and that important decision points are properly tracked and resolved.

The output generation module 360 may synthesize the analysis results from the decision phase into unified outputs that appropriately address the collective input. The synthesis process may implement a decision tree that routes to different output types based on the detected input characteristics.

When the decision phase identifies aligned instruction sets with no detected conflicts, the synthesis process merges the aligned directives into a coherent action plan or response. The merging process may identify the minimal set of actions that satisfies all aligned directives and may present this action set in a consolidated response. If the aligned directives include explicit action requests, the AI agent may execute the actions directly and report the results in the unified output. If the directives are informational or advisory, the unified output may synthesize the information into a coherent summary that reflects the collective input.

When the decision phase identifies conflicting instruction sets, the synthesis process may evaluate the conflict characteristics to determine the appropriate response type. For conflicts that may be resolved through priority weights (where one directive clearly takes precedence), the unified output may describe the selected course of action and briefly acknowledge the alternative directive. For conflicts that require human resolution, the unified output poses a clarifying question that explicitly identifies the conflicting directives and requests guidance on resolution. The clarifying question may be formulated to facilitate efficient resolution by presenting the specific decision point, the alternatives, and any relevant context that may inform the decision.

For interdependent conflicting instruction sets where execution of any individual directive may require prior resolution of the conflict (for example, when two users request incompatible modifications to the same shared resource), the unified output may explicitly identify the interdependency and defer action until resolution. The output message may identify the aligned directives that can proceed independently, explain why the conflicting directives are interdependent, and request guidance on the specific decision needed to enable further progress.

The unified output is formatted as a single message attributed to the AI agent and transmitted to the multi-user interface. The message content may optionally be structured to address all participants who contributed to the context window, using explicit references or @mentions where appropriate to direct specific portions of the response to specific users. The formatting may maintain the natural conversational style expected in the platform's messaging interface, avoiding overly formal or robotic language that would disrupt the conversational flow.

When the unified output includes a clarifying query posed to resolve conflicts between user directives, the system may establish a sub-context window specifically for receiving and processing responses to the clarifying query. The context window manager 330 may create a nested context window structure where the parent context window contains the original multi-user inputs that triggered the conflict, and a child sub-context window is opened to collect responses to the clarifying query.

The sub-context window operates under similar principles as the primary context window but may employ adjusted temporal boundaries and semantic coherence thresholds optimized for focused responses to a specific question. For example, the sub-context window duration may be shorter than the primary window since responses to a clarifying query are typically more focused and require less extended discussion time. The sub-context window may remain open until either: (a) all users who contributed to the original conflicting directives have provided responses, (b) a predetermined timeout period has elapsed (e.g., 10 minutes for synchronous contexts, 24 hours for asynchronous contexts), or (c) a sufficient number of responses have been received to enable conflict resolution.

Once the sub-context window closes, the decision phase processes the collected responses through the same analysis pipeline, identifying whether the responses have achieved consensus, whether further conflicts have emerged, or whether the responses enable synthesis of the original conflicting directives. The output generation module 360 then generates a follow-up unified output that incorporates the responses to resolve the initial conflict. This may take forms including: “Based on your responses, we'll proceed with Option A as preferred by the majority” (when responses indicate clear consensus), execution of a synthesized action that incorporates elements from multiple responses, or generation of an additional clarifying query if the responses reveal new conflicts or ambiguities requiring further resolution.

This iterative clarification mechanism enables the AI agent to progressively narrow conflicting positions through structured dialogue until actionable consensus emerges, while maintaining explicit tracking of the resolution process through the hierarchical context window structure.

Reference is now made to FIG. 4, which is a flowchart illustrating a method corresponding to the system of FIG. 3. The method begins at step 410 with receiving input messages from at least two distinct users within defined time windows that establish context windows. Each input message is timestamped and associated with unique user identifiers, and context windows are expanded as additional participants add context.

At step 420, the system executes decision phases comprising identification of distinct instruction sets within context windows and determination of which instruction sets align with each other and which conflict with each other. The decision phase may optionally include evaluation of whether conflicting instruction sets are interdependent such that execution is deferred until resolution.

The decision phase execution at step 420 may comprise sub-steps including: identifying distinct instruction sets within the context window; determining alignment relationships between instruction sets; and determining conflict relationships between instruction sets.

The unified output generation at step 430 may comprise sub-steps including: computationally fusing aligned instruction sets; identifying resolution strategies for conflicting instruction sets; and formulating clarifying queries or consolidated responses.

At step 430, the system generates unified outputs by computationally fusing distinct instruction sets that align with each other and instruction sets that conflict with each other. Conflicting directives trigger generation of clarifying queries directed to multiple users, while non-conflicting directives are merged into executable actions or consolidated responses. At step 440, the system transmits unified outputs to multi-user interfaces as single responses attributed to AI agents.

According to one optional embodiment recited with reference to FIGS. 3 and 4, the decision phase may further comprise evaluating whether conflicting instruction sets are interdependent such that execution is deferred until resolution. These embodiments may provide prevention of premature action execution, maintained system consistency during conflict resolution, and improved collaborative decision-making through dependency management.

According to one or more other optional embodiments recited with reference to FIGS. 3 and 4, processing input messages may comprise extracting factual assertions and sentiment indicators from each input message, constructing conflict detection matrices identifying contradictory directives between users, and assigning priority weights to each input message based on user roles, message timestamps, and detected confidence levels. These embodiments may provide sophisticated conflict detection, intelligent priority assignment, and enhanced decision-making accuracy through multi-factor analysis.

According to one or more other optional embodiments recited with reference to FIGS. 3 and 4, generating unified outputs may comprise computationally fusing conflicting directives and non-conflicting directives according to priority weights and conflict detection matrices. These embodiments may provide systematic conflict resolution, weighted decision-making, and consistent output generation across diverse input scenarios.

In optional embodiments, the disclosed system may implement fine-grained access control mechanisms that govern visibility and modification rights for persistent UI widgets. Each widget may be associated with an access scope that determines which users and AI agents can view and interact with the widget.

Optional platform-level access scope may configure the widget to be visible to all users within the account who have access to the conversation or workspace in which the widget was created. This scope may be appropriate for widgets that display generally relevant information such as project status dashboards or team metrics. Optional team-level access scope may restrict widget visibility to designated team members, enabling creation of widgets that contain team-specific information not appropriate for broader distribution. Optional user-level access scope may limit widget visibility to the individual user's profile, enabling personal productivity widgets that are not shared with other users.

Access scope enforcement may optionally be implemented at multiple system layers. At the server layer, API requests to retrieve or modify widget data may be validated against the requesting user's permissions and the widget's access scope. At the client layer, the UI rendering engine may filter the set of widgets presented to each user based on access scope, preventing unauthorized widgets from being displayed. At the data storage layer, widgets with restricted access scopes may be stored with encryption keys that are accessible only to authorized users.

When multiple AI agents may operate within the same conversational context (for example, when a user's personal AI agent and a team-level AI agent are both participating), the system may optionally implement coordination mechanisms to prevent conflicts. Each AI agent may be assigned a modification scope that defines which widgets the agent may modify. When an agent attempts to modify a widget outside its modification scope, the system may either block the modification or route the modification request through an approval workflow.

Optional conflict resolution mechanisms may handle cases where multiple AI agents attempt to modify the same widget concurrently. The system may maintain a widget lock registry that tracks active modification operations. When an agent initiates a widget modification, it may acquire an advisory lock on the widget. If another agent attempts to modify the same widget while a lock is held, the system may queue the second modification and process it after the first modification completes. For real-time collaborative scenarios where lock-based serialization would introduce unacceptable latency, the system may optionally employ operational transformation or conflict-free replicated data type (CRDT) techniques to merge concurrent modifications.

In optional embodiments, the disclosed system may implement progressive interface evolution wherein the messaging GUI transitions from an initial chat-only configuration to increasingly sophisticated hybrid interfaces as the system learns about user workflows and requirements. This evolution may occur automatically based on accumulated conversational context and may not require explicit user configuration.

During initial interactions with a new user, the messaging GUI may present a conventional chat interface with minimal persistent widgets. As the user engages in conversations and the system accumulates conversational context, the AI agent may identify opportunities for widget generation based on detected patterns. The first widgets introduced may typically be simple and low-risk, such as a summary widget that displays key entities mentioned in the conversation or a quick-action widget that provides one-click access to frequently referenced items.

As the user demonstrates acceptance of initial widgets through continued interaction, the system may progressively introduce more sophisticated widgets. The progression may follow a complexity hierarchy: information display widgets (showing data without modification capability) may be introduced before interactive widgets (allowing data modification), and single-entity widgets may be introduced before multi-entity aggregation widgets. This progressive approach may enable users to develop familiarity with the hybrid interface paradigm while minimizing the risk of overwhelming users with excessive interface complexity.

An optional proactive widget suggestion mechanism may trigger widget recommendations without explicit user requests when the conversational context indicates potential utility. The triggering logic may evaluate a set of learned conditions including: repeated queries about the same type of information (suggesting that a persistent display would reduce query repetition), expressed frustration with information access (detected through sentiment analysis), explicit statements of workflow challenges that widgets could address, and observation of successful widget usage in similar contexts by other users with comparable roles or workflows.

When the proactive suggestion mechanism may be triggered, the system may generate a widget preview that appears in the message stream as a suggestion message from the AI agent. The suggestion message may briefly explain why the widget might be helpful and may display a visual preview of the proposed widget. The user may accept the suggestion (causing the widget to be instantiated as a persistent UI element), dismiss the suggestion (causing it to be removed from the message stream), or defer the suggestion (causing it to be saved for later consideration). User responses to proactive suggestions may be recorded and used to refine the triggering logic, reducing future suggestions for widget types that the user consistently declines.

The following exemplary use cases optionally illustrate operation of the disclosed systems within a SaaS project management platform context.

In a first optional use case, a product manager may initiate a messaging session with the AI agent to discuss sprint planning. The product manager writes: “Let's review the current sprint status and figure out what we can realistically complete.” The natural language processing component may parse this message and extract the intent (status review and planning), the entity reference (current sprint), and the implicit request for prioritization analysis. The context analysis component may retrieve the product manager's organizational context, identify the current sprint in the project management data, and query related items including all tasks assigned to the current sprint.

Based on the detected planning intent and the availability of sprint data, the widget generation component may create a sprint status widget that displays all sprint items organized by status (not started, in progress, blocked, complete), with each item showing its title, assignee, story point estimate, and days remaining until sprint end. The widget may include visual indicators highlighting items that are at risk of non-completion based on remaining time and historical velocity data. The widget may be rendered in a panel adjacent to the message stream, and the AI agent may respond conversationally: “I've created a sprint overview panel. Based on the current velocity and remaining capacity, it looks like the auth refactor and the dashboard updates are both at risk. Want me to suggest re-prioritization options?”

The product manager may continue the conversation, and the AI agent may update the widget in response to conversational inputs. When the product manager writes “Let's move the dashboard updates to the next sprint,” the widget may immediately reflect this change, moving the relevant items to a “deferred” section while also updating the risk indicators for remaining items. The state synchronization manager may simultaneously update the underlying project management database to record the sprint reassignment.

In a second optional use case, a cross-functional team may discuss incident response in a shared channel with an AI agent present. Multiple team members may contribute messages nearly simultaneously: the on-call engineer writes “The database is timing out, we need to scale up immediately,” the product manager writes “Customer impact is critical, we need status updates every 15 minutes,” and the engineering manager writes “Hold off on changes until we have root cause analysis.” The multi-user input processing system receives all three messages within a 30-second context window.

The decision phase identifies aligned instruction sets (all participants agree the incident is high priority and requires attention) and conflicting instruction sets (the on-call engineer requests immediate action while the engineering manager requests deferral pending analysis). The conflict detection matrix may classify this as an interdependent conflict because the requested action (scaling up) and the requested deferral concern the same remediation decision.

The output generation module may produce a unified response: “I understand this is a critical incident. I've noted the following aligned priorities: high severity classification, customer-facing impact, and need for regular status updates. However, I've detected a conflict between immediate scaling action and waiting for root cause analysis. These are interdependent—can the team clarify whether to proceed with scaling as a mitigation step while analysis continues in parallel, or to hold all changes pending root cause identification? I'll begin preparing status update summaries per the 15-minute interval request.”

The AI agent may simultaneously generate a persistent incident widget that displays the incident timeline, current status, affected systems, and a log of decisions and actions. This widget may remain visible throughout the incident response conversation, providing a shared reference point that reduces the need for participants to re-state context.

In a third optional use case, a sales team may use an AI agent during opportunity review meetings. As team members discuss specific deals, the AI agent may detect entity references corresponding to CRM records and may automatically retrieve related context including recent email communications, scheduled meetings, competitor mentions, and historical interactions with the same customer organization. Based on the detected sales context intent, the agent may generate a deal context widget that displays opportunity value, stage, close date, stakeholder map, and recent activity timeline.

When one team member mentions “We should involve the technical architect for the demo,” the AI agent may detect the resource coordination intent and may present a scheduling widget that shows the technical architect's availability overlaid with the customer's indicated preferences extracted from email communications. The team member may directly book the meeting through the widget without leaving the conversation context, and the confirmation may be reflected in both the widget state and the conversational stream.

In optional embodiments, the disclosed systems may be architected for deployment in multi-tenant SaaS environments where a single platform instance serves multiple organizational accounts with strict data isolation requirements. The architecture may implement tenant isolation at multiple levels to ensure that conversational context, widget state, and AI agent behavior are appropriately segregated between tenants.

At the data storage level, each tenant's conversational context and widget state may be stored in logically isolated database schemas or physically separate database instances depending on the tenant's security requirements. Encryption keys for tenant data may be managed through a key management service with tenant-specific key hierarchies, ensuring that data from one tenant cannot be decrypted using keys from another tenant.

At the AI model level, the base language models and widget generation models may be shared across tenants to maximize resource efficiency, but fine-tuning layers and tenant-specific customizations may be maintained separately. The inference pipeline may apply tenant-specific model configurations at runtime based on the authenticated tenant context associated with each request. This architecture may enable tenants to benefit from improvements to shared model components while maintaining the ability to customize behavior for their specific workflows and terminology.

At the application level, the messaging GUI and widget rendering components may be served from a common codebase but may be configured dynamically based on tenant-specific branding, feature flags, and access policies. Tenant administrators may configure which widget types are available within their organization, may set default visibility policies for widgets created by users, and may establish organizational vocabularies that improve entity extraction accuracy for industry-specific or organization-specific terminology.

The system may optionally implement horizontal scalability through stateless application server design combined with distributed state management. Application servers may process requests without maintaining in-memory session state, relying instead on distributed caches (such as Redis clusters) for session context and messaging infrastructure (such as Kafka) for event propagation. This architecture may enable elastic scaling in response to demand, with automatic instance provisioning during peak usage periods and deprovisioning during low-usage periods.

According to one or more other optional embodiments recited with reference to FIGS. 3 and 4, unified outputs may represent synthesized interpretations of collective intent derived from multiple input messages. These embodiments may provide enhanced collaborative efficiency, improved group consensus building, and reduced communication overhead through intelligent synthesis. The synthesized collective intent may be represented as one or more alignment clusters, each with associated confidence/priority weights, and an unresolved discussion points list derived from conflict clusters.

According to one or more other optional embodiments recited with reference to FIGS. 3 and 4, AI agents may operate as full participants in multi-user chat threads, functioning as context-fused team participants within multi-user interfaces. These embodiments may provide seamless team integration, natural collaborative workflows, and enhanced team productivity through intelligent AI participation.

According to one or more other optional embodiments recited with reference to FIGS. 3 and 4, the system may include multi-perspective synthesis engines that reconcile diverse inputs to co-construct shared intent reflecting group goals. These embodiments may provide technical benefits including intelligent consensus building, improved group alignment, and enhanced collaborative decision-making through systematic input synthesis.

According to one or more other optional embodiments recited with reference to FIGS. 3 and 4, unified outputs may comprise clarifying questions posed to resolve detected conflicts between user directives, consolidated summaries synthesizing information from all input messages, or single executed actions incorporating fused directives from multiple users. These embodiments may provide technical benefits including appropriate response selection, comprehensive information synthesis, and efficient action execution based on multi-user input.

In an optional exemplary use case, a project management team may utilize the AI agent system during a product planning meeting. Team members may engage in conversational interaction with the AI agent through the messaging interface, discussing project timelines, resource allocation, and feature priorities. As the conversation progresses, the AI agent may identify recurring references to project milestones and may automatically generate a persistent project tracking widget that displays key dates and deliverables.

The project manager may ask about current sprint progress, triggering the creation of a sprint status dashboard widget that shows completion percentages and remaining tasks. When team members discuss budget constraints, the AI agent may generate a resource allocation chart that visualizes current spending against budget limits. These persistent widgets may remain visible alongside the chat interface, allowing team members to reference visual information while continuing conversational interactions.

During the meeting, multiple team members may provide simultaneous input about feature prioritization. The AI agent processes these concurrent inputs, identifies areas of alignment regarding high-priority features, and detects conflicts regarding resource allocation for competing features. The AI agent generates a unified response that summarizes agreed-upon priorities and poses clarifying questions about resource conflicts, enabling efficient resolution of disagreements while maintaining momentum in the collaborative discussion.

The persistent widgets created during the meeting may remain available across subsequent sessions, allowing team members to continue building upon established visual context without recreating interface components. Multiple AI agents may access and update these widgets, enabling seamless handoffs between different AI agent instances while maintaining consistent visual and data context.

As described herein, the generative AI agent may use a generative AI model for enabling interactions with SaaS platform data and user queries. The architecture may optionally be based on a hybrid approach, combining several advanced machine learning techniques such as transformer-based architecture similar to GPT (Generative Pre-trained Transformer) models. Multi-head self-attention mechanisms for processing both textual and structured data may optionally be used, with positional encoding to maintain sequence information in input data and layer normalization and residual connections for stable training and inference.

Optionally, multimodal processing may incorporate separate encoding branches for different data types including text, tabular data, and images. Byte-pair encoding (BPE) may optionally be used for tokenization. Entity embeddings for categorical variables and normalized numerical inputs may be used for processing tabular data. A convolutional neural network (CNN) backbone, such as ResNet or EfficientNet, may optionally be used for analyzing images built from marked areas and pixels.

Cross-attention layers may optionally be added to allow interaction between different modalities and to enable the model to align information from text queries with relevant parts of tabular or image data. In optional multi-interaction processes, a context buffer may be maintained to store relevant information from previous interactions. Attention mechanisms may be used to selectively retrieve and apply contextual information. An autoregressive decoder may optionally be used for generating text responses, optionally with pointer networks for referencing specific parts of input data in responses and mixture of expert modules for specialized outputs such as SQL generation and data visualizations.

The generative AI model may optionally be an outcome of pre-training on large corpus of SaaS platform data and optionally general knowledge bases. The model may optionally be fine-tuned on specific customer datasets and use cases, enabling domain-specific performance optimization and enhanced accuracy for particular application contexts.

The foregoing description has been presented for purposes of illustration. It is not exhaustive and is not limited to the precise forms or embodiments disclosed. Modifications and adaptations will be apparent to those skilled in the art from consideration of the specification and practice of the disclosed embodiments.

Moreover, while illustrative embodiments have been described herein, the scope of any and all embodiments having equivalent elements, modifications, omissions, combinations (e.g., of aspects across various embodiments), adaptations and/or alterations as would be appreciated by those skilled in the art based on the present disclosure. The limitations in the claims are to be interpreted broadly based on the language employed in the claims and not limited to examples described in the present specification or during the prosecution of the application. The examples are to be construed as non-exclusive. Furthermore, the steps of the disclosed methods may be modified in any manner, including by reordering steps and/or inserting or deleting steps. It is intended, therefore, that the specification and examples be considered as illustrative only, with a true scope and spirit being indicated by the following claims and their full scope of equivalents.

Unless otherwise defined, all technical and scientific terms used herein have the same meaning as commonly understood by one of ordinary skill in the art. The materials, methods, and examples provided herein are illustrative only and not intended to be limiting.

Implementation of the method and system of the present disclosure may involve performing or completing certain selected tasks or steps manually, automatically, or a combination thereof. Moreover, according to actual instrumentation and equipment of preferred embodiments of the method and system of the present disclosure, several selected steps may be implemented by hardware (HW) or by software (SW) on any operating system of any firmware, or by a combination thereof. For example, as hardware, selected steps of the disclosure could be implemented as a chip or a circuit. As software or algorithm, selected steps of the disclosure could be implemented as a plurality of software instructions being executed by a computer using any suitable operating system. In any case, selected steps of the method and system of the disclosure could be described as being performed by a data processor, such as a computing device for executing a plurality of instructions.

As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

Although the present disclosure is described with regard to a “computing device”, a “computer”, or “mobile device”, it should be noted that optionally any device featuring a data processor and the ability to execute one or more instructions may be described as a computing device, including but not limited to any type of personal computer (PC), a server, a distributed server, a virtual server, a cloud computing platform, a cellular telephone, an IP telephone, a smartphone, a smart watch or a PDA (personal digital assistant). Any two or more of such devices in communication with each other may optionally include a “network” or a “computer network”.

To provide for interaction with a user, the systems and techniques described here can be implemented on a computer having a display device (a LED (light-emitting diode), or OLED (organic LED), or LCD (liquid crystal display) monitor/screen) for displaying information to the user and a touch-sensitive layer such as a touchscreen, or keyboard and a pointing device (e.g., a mouse or a trackball), by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (“LAN”), a wide area network (“WAN”), and the Internet.

The computing system can include clients and servers. A client and server are generally remote from each other and may interact through a communication network. The relationship of client and server arises by virtue of computer programs running on the respective computers and having a client-server relationship to each other.

It should be appreciated that the above-described methods and apparatus may be varied in many ways, including omitting or adding steps, changing the order of steps and the type of devices used. It should be appreciated that different features may be combined in different ways. In particular, not all the features shown above in a particular embodiment or implementation are necessary in every embodiment or implementation of the invention. Further combinations of the above features and implementations are also considered to be within the scope of some embodiments or implementations of the invention.

While certain features of the described implementations have been illustrated as described herein, many modifications, substitutions, changes and equivalents will now occur to those skilled in the art. It is, therefore, to be understood that the appended claims are intended to cover all such modifications and changes as fall within the scope of the implementations. It should be understood that they have been presented by way of example only, not limitation, and various changes in form and details may be made. Any portion of the apparatus and/or methods described herein may be combined in any combination, except mutually exclusive combinations. The implementations described herein can include various combinations and/or sub-combinations of the functions, components and/or features of the different implementations described.

The systems and methods disclosed herein provide specific technical improvements including: (1) reduction in user interface reconstruction time by maintaining persistent widget state across sessions, eliminating the need for repeated manual widget creation; (2) improved computational efficiency through context-aware widget generation that reduces unnecessary widget instantiation; (3) enhanced data synchronization accuracy through bidirectional state management between conversational and structured interface modalities; and (4) reduced network bandwidth utilization through incremental widget updates rather than full interface re-rendering.

Additionally, the disclosed embodiments are not limited to the examples discussed herein.

The foregoing description has been presented for purposes of illustration. It is not exhaustive and is not limited to the precise forms or embodiments disclosed. Modifications and adaptations of the embodiments will be apparent from consideration of the specification and practice of the disclosed embodiments. For example, the described implementations include hardware and software, but systems and methods consistent with the present disclosure may be implemented as hardware alone.

It should be appreciated that the above-described embodiments can be implemented by hardware, or software (program codes), or a combination of hardware and software. If implemented by software, it can be stored in the above-described computer-readable media. The software, when executed by the processor can perform the disclosed methods. The computing units and other functional units described in the present disclosure can be implemented by hardware, or software, or a combination of hardware and software. One of ordinary skill in the art will also understand that multiple ones of the above-described logic/modules/units can be combined as one logic/module or unit, and each of the above-described modules/units can be further divided into a plurality of sub-modules or sub-units.

The block diagrams in the figures illustrate the architecture, functionality, and operation of possible implementations of systems, methods, and computer hardware or software products according to various example embodiments of the present disclosure. In this regard, each block in a flowchart or block diagram may represent a module, segment, or portion of code, which includes one or more executable instructions for implementing the specified logical functions. It should be understood that in some alternative implementations, functions indicated in a block may occur out of order noted in the figures. For example, two blocks shown in succession may be executed or implemented substantially concurrently, or two blocks may sometimes be executed in reverse order, depending upon the functionality involved. Some blocks may also be omitted. It should also be understood that each block of the block diagrams, and combination of the blocks, may be implemented by special purpose hardware-based systems that perform the specified functions or acts, or by combinations of special purpose hardware and computer instructions.

In the foregoing specification, embodiments have been described with reference to numerous specific details that can vary from implementation to implementation. Certain adaptations and modifications of the described embodiments can be made. Other embodiments can be apparent to those skilled in the art from consideration of the specification and practice of the invention disclosed herein. It is intended that the specification and examples be considered as example only, with a true scope and spirit of the invention being indicated by the following claims. It is also intended that the sequence of steps shown in figures are only for illustrative purposes and are not intended to be limited to any particular sequence of steps. As such, those skilled in the art can appreciate that these steps can be performed in a different order while implementing the same method.

It will be appreciated that the embodiments of the present disclosure are not limited to the exact construction that has been described above and illustrated in the accompanying drawings, and that various modifications and changes may be made without departing from the scope thereof. Other embodiments will be apparent to those skilled in the art from consideration of the specification and practice of the disclosed embodiments disclosed herein. It is intended that the specification and examples be considered as exemplary only, with a true scope and spirit of the disclosed embodiments being indicated by the following claims.

Computer programs based on the written description and methods of this specification are within the skill of a software developer. The various programs or program modules can be created using a variety of programming techniques. One or more of such software sections or modules can be integrated into a computer system, non-transitory computer readable media, or existing software.

This disclosure employs open-ended permissive language, indicating for example, that some embodiments “may” employ, involve, or include specific features. The use of the term “may” and other open-ended terminology is intended to indicate that although not every embodiment may employ the specific disclosed feature, at least one embodiment employs the specific disclosed feature.

Various terms used in the specification and claims may be defined or summarized differently when discussed in connection with differing disclosed embodiments. It is to be understood that the definitions, summaries and explanations of terminology in each instance apply to all instances, even when not repeated, unless the transitive definition, explanation or summary would result in inoperability of an embodiment.

Moreover, while illustrative embodiments have been described herein, the scope includes any and all embodiments having equivalent elements, modifications, omissions, combinations (e.g., of aspects across various embodiments), adaptations or alterations based on the present disclosure. The elements in the claims are to be interpreted broadly based on the language employed in the claims and not limited to examples described in the present specification or during the prosecution of the application. These examples are to be construed as non-exclusive. Further, the steps of the disclosed methods can be modified in any manner, including by reordering steps or inserting or deleting steps. It is intended, therefore, that the specification and examples be considered as exemplary only, with a true scope and spirit being indicated by the following claims and their full scope of equivalents.

The terms “comprises”, “comprising”, “includes”, “including”, “having” and their conjugates mean “including but not limited to”.

The term “consisting of” means “including and limited to”.

The term “consisting essentially of” means that the composition, method or structure may include additional ingredients, steps and/or parts, but only if the additional ingredients, steps and/or parts do not materially alter the basic and novel characteristics of the claimed composition, method or structure.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

It is the intent of the Applicant(s) that all publications, patents and patent applications referred to in this specification are to be incorporated in their entirety by reference into the specification, as if each individual publication, patent or patent application was specifically and individually noted when referenced that it is to be incorporated herein by reference. In addition, citation or identification of any reference in this application shall not be construed as an admission that such reference is available as prior art to the present invention. To the extent that section headings are used, they should not be construed as necessarily limiting. In addition, any priority document(s) of this application is/are hereby incorporated herein by reference in its/their entirety.

What is claimed is:

1. A system for generating an adaptive user interface, comprising: a processor and memory storing instructions that, when executed, cause the system to:
present a messaging GUI enabling exchange of messages between a user and an instance of an AI agent in a messaging session, wherein the messaging GUI comprises a message stream;
parse natural language inputs from user messages in the messaging session;
maintain a conversational context of the messaging session based on analysis of the parsed natural language inputs, wherein at least the messages relating to the UI widgets are maintained;
based on the conversational context, create one or more persistent UI widgets;
render the one or more persistent UI widgets as part of the messaging GUI,
update the one or more persistent UI widgets rendered in the messaging GUI, as the user continues interactions with the AI agent, wherein the update comprises adding, removing, or modifying the one or more persistent UI widgets responsive to changes in the conversational context.

2. The system of claim 1, wherein the processor and memory storing instructions that, when executed, cause the system to enable hybrid interaction wherein the user can seamlessly alternate between issuing natural language commands through a chat interface and performing structured operations through the persistent UI widgets, with state synchronization maintained between both interaction modalities.

3. The system of claim 1, wherein the one or more persistent UI widgets are rendered such that they at least one of:
(i) remains visually fixed within the messaging GUI independent of the scrolling message stream; and
(ii) persists across multiple user sessions.

4. The system of claim 1, wherein parse the natural language inputs comprises:
extracting semantic entities from the natural language inputs;
identifying recurring interaction patterns in the natural language inputs; and
assigning context scores indicating a probability that structured visualization would enhance user task completion.

5. The system of claim 4, wherein update the one or more persistent UI widgets comprises selecting the one or more persistent UI widgets from a widget library based on the context scores exceeding a predetermined threshold.

6. The system of claim 4, wherein each of the one or more persistent UI widgets is programmatically configured with data bindings linked to the extracted semantic entities.

7. The system of claim 4, wherein the updates to the one or more persistent UI widgets are triggered by detected shifts in user intent or introduction of new semantic entities identified during the parsing.

8. The system of claim 1, wherein the one or more persistent UI widgets are accessible to multiple AI agents for interaction and adaptation.

9. The system of claim 1, wherein the graphical interface panel progressively evolves from an initial chat-only interface to include increasingly complex UI widgets as the system learns about user workflows and requirements.

10. The system of claim 1, wherein the one or more persistent UI widgets comprise at least one of: data visualization widgets, charts, status trackers, project tracking widgets, metric dashboards, or control panels selected based on the conversational context.

11. The system of claim 1, wherein the graphical interface panel is rendered as one of:
an integrated panel displayed alongside the chat interface; or
a dedicated dashboard maintained separately from but synchronized with the chat interface.

12. The system of claim 4, wherein identifying recurring interaction patterns comprises:
detecting repeated queries about specific data types or metrics;
identifying patterns suggesting need for visual data representation; and
tracking frequency of requests for status updates or progress tracking.

13. The system of claim 1, wherein the instructions further cause the system to:
generate a widget recommendation based on historical interaction patterns across multiple users with similar workflows; and
proactively suggest new UI widgets before explicit user request when the conversational context indicates potential utility.

14. The system of claim 1, wherein state synchronization between interaction modalities comprises:
automatically updating widget displays when relevant information is provided through the chat interface; and
reflecting widget-based actions in the conversational context for the AI agent's awareness.

15. The system of claim 4, wherein the system autonomously triggers widget generation by:
detecting predefined conversation patterns through analysis of the parsed natural language inputs;
generating a visual preview of a potential widget based on the detected patterns; and
presenting the visual preview to the user through the chat interface with an option to create the actual persistent widget.

16. The system of claim 1, wherein the system manages access to persistent UI widgets by:
implementing a conflict resolution mechanism when multiple AI agents attempt to modify the same persistent UI widget;
establishing modification priority protocols; and
maintaining data consistency across concurrent widget interactions.

17. The system of claim 1, wherein each persistent UI widget is associated with a defined access scope selected from:
platform-level access enabling visibility to all users;
team-level access restricting visibility to designated team members; and
user-level access limiting visibility to individual user profiles.

18. The system of claim 17, wherein the system enforces access scope restrictions by: filtering widget visibility based on user authorization levels; and controlling which conversational contexts can interact with each widget based on the defined access scope.

19. The system of claim 1, wherein the system maintains widget data provenance by:
storing source attribution data indicating whether widget data originates from user-specific sources, AI agent-generated sources, or platform-wide sources; and preserving linkage information connecting widget modifications to specific conversational messages that triggered the modifications.

20. The system of claim 19, wherein the conversational context includes:
temporal markers indicating when specific entities were introduced in the conversation;
frequency tracking of concept references across sessions; and source of truth indicators for each data element within the persistent UI widgets.

21. The system of claim 1, wherein the one or more persistent UI widgets are stored in association with a user account identifier, enabling multiple AI agent instances operating under the same user account to at least one of access, modify, and synchronize the widget state across different messaging sessions.

22. A method for generating an adaptive user interface, comprising:
presenting a messaging GUI enabling exchange of messages between a user and an instance of an AI agent in a messaging session, wherein the messaging GUI comprises a message stream;
parsing natural language inputs from user messages in the messaging session;
maintaining a conversational context of the messaging session based on analysis of the parsed natural language inputs, wherein at least the messages relating to the UI widgets are maintained;
based on the conversational context, creating one or more persistent UI widgets;
rendering the one or more persistent UI widgets as part of the messaging GUI,
updating the one or more persistent UI widgets rendered in the messaging GUI, as the user continues interactions with the AI agent, wherein the update comprises adding, removing, or modifying the one or more persistent UI widgets responsive to changes in the conversational context.
